(19) United States
(12) Patent Application Publication
(10) Pub. No.: US 2024/0066900 A1
(43) Pub. Date: Feb. 29, 2024

(54) RECORDING DEVICE

(71) Applicant: SEIKO EPSON CORPORATION, Tokyo (JP)

(72) Inventor: Takuto TANAKA, SHIOJIRI-SHI (JP)

(21) Appl. No.: 18/457,789

(22) Filed: Aug. 29, 2023

(30) Foreign Application Priority Data
Aug. 31, 2022 (JP) 2022-138295

(51) Int. Cl. B41J 25/00

(52) U.S. Cl. CPC B41J 25/001

(57) ABSTRACT

A recording device is with a mobile body configured to be able to move and be attachable and detachable. The mobile body includes a recording unit configured to perform recording on a medium or a maintenance unit configured to perform maintenance of the recording unit. The recording device includes: the mobile body; a first guide portion configured to guide the mobile body along a movement direction; a second guide portion bifurcating from the first guide portion and configured to guide the mobile body along a attachment and detachment direction intersecting the movement direction; and a restricting portion. The restricting portion is configured to restrict movement of the mobile body along the attachment and detachment direction, when the mobile body is disposed at a replacement position where the second guide unit bifurcates from the first guide unit and attachment and detachment are possible.

The present application is based on, and claims priority from JP Application Serial Number 2022-138295, filed on Aug. 31, 2022, the disclosure of which is hereby incorporated by reference herein in its entirety.

### BACKGROUND

### 1. Technical Field

The present disclosure relates to a recording device including a recording unit configured to perform recording on a medium such as a sheet.

### 2. Related Art

For example, JP-A-2022-55781 discloses a recording device including a recording unit. In this recording device, a head unit (serving as one example of a mobile body) moves along a guide rail. The head unit moves along a first direction (serving as one example of a movement direction) to be placed at a plurality of stop positions. The recording device includes, as one of the stop positions, a replacement position where the recording unit can be replaced. A guide rail used to make replacement and extending in a second direction intersecting the first direction in which the guide rail extends is coupled at the replacement position in the guide rail extending in the first direction. In other words, at the replacement position, the guide rail bifurcates and is coupled to the guide rail used to make replacement. At positions other than the replacement position, for example, a guide roller at the head unit side is restricted by a wall portion of the guide rail, and hence, the displacement of a mobile body in a second direction is restricted. The head unit is driven through a movement mechanism such as a rack and pinion mechanism so as to move in the first direction.

However, in a case of the recording device described in JP-A-2022-55781, when the mobile body is further moved in the first direction in a state where the mobile body is disposed at the replacement position due to maintenance or replacement, there is a possibility that the mobile body is unintentionally moved in the second direction due to driving force, which is a problem. Note that this problem not only happens in a case where the mobile body is a recording unit such as a head unit, and a similar problem can also happen in a case where the mobile body is a maintenance unit or the like such as a cap unit or a wiper unit configured to perform maintenance to the recording head.

### SUMMARY

A recording device configured to solve the problem described above provides a recording device with a mobile body configured to move and be attachable and detachable, the mobile body including a recording unit configured to perform recording on a medium or a maintenance unit configured to perform maintenance of the recording unit, the recording device including the mobile body, a first guide portion configured to guide the mobile body along a movement direction, a second guide portion bifurcating from the first guide portion and configured to guide the mobile body along a attachment and detachment direction intersecting the movement direction, and a restricting portion configured to restrict movement of the mobile body based on driving force causing the mobile body to move in the movement direction and along the attachment and detachment direction, when the mobile body is disposed at a replacement position where the second guide portion bifurcates from the first guide portion and the mobile body is attachable and detachable.

### BRIEF DESCRIPTION OF THE DRAWINGS

FIG. 1 is a perspective view illustrating a recording device according to a first embodiment.

FIG. 2 is a front cross-sectional view schematically illustrating the configuration of the inside of the recording device.

FIG. 3 is a perspective view illustrating a motion unit.

FIG. 4 is a perspective view illustrating a recording unit.

FIG. 5 is a perspective view illustrating a portion of the recording unit and an adjustment unit.

FIG. 6 is a perspective view illustrating the main components of the motion unit.

FIG. 7 is a schematic front view illustrating a state in which the recording unit is disposed at a replacement position.

FIG. 8 is a schematic front view illustrating a state in which the recording unit is taken off from the replacement position.

FIG. 9 is a schematic front view illustrating a mobile body and a guide rail configured to guide the mobile body.

FIG. 10 is a perspective view illustrating a motion unit including a restriction mechanism.

FIG. 11 is a front view illustrating a recording unit disposed at a replacement position and a restriction mechanism.

FIG. 12 is an enlarged schematic front view illustrating a restriction mechanism when the recording unit is disposed at the replacement position.

FIG. 13 is a schematic front view illustrating a state in which a restricted portion is brought into contact with a restriction surface of a restricting portion.

FIG. 14 is a front view illustrating a process of pulling out the recording unit from the replacement position.

FIG. 15 is also a front view illustrating a process of pulling out the recording unit from the replacement position.

FIG. 16 is also a front view illustrating a process of pulling out the recording unit from the replacement position.

FIG. 17 is a front view illustrating a restriction mechanism when a recording unit according to a second embodiment is disposed at the replacement position.

FIG. 18 is a front view illustrating the restriction mechanism.

FIG. 19 is a front view illustrating a process of pulling out the recording unit from the replacement position.

FIG. 20 is a front view illustrating a process of pulling out the recording unit from the replacement position.

### DESCRIPTION OF EMBODIMENTS

Below, embodiment will be described with reference to the drawings. A recording device 11 is, for example, a multifunction device. The recording device 11 has a plurality of functions including a scanning function, a copying function, and a printing function. In the drawings, it is assumed that the recording device 11 is disposed at a horizontal installation surface. Of the Z-axis perpendicular to the installation surface of the recording device 11, the upward direction is set as the +Z direction, and the downward direction is set as the −Z direction. Two axes perpendicular to the Z-axis are each set as the X-axis and the Y-axis. In addition, the X direction parallel to the X-axis includes both directions of the +X direction and the −X direction. The X direction parallel to the X-axis is a width direction of a medium M, and hence, is also referred to as a width direction X. The Y direction parallel to the Y-axis includes both directions of the +Y direction and the −Y direction. The Y direction parallel to the Y-axis is also referred to as a horizontal direction Y. The Z direction parallel to the Z-axis is also referred to as a vertical direction Z.

Entire Configuration of Recording Device 11

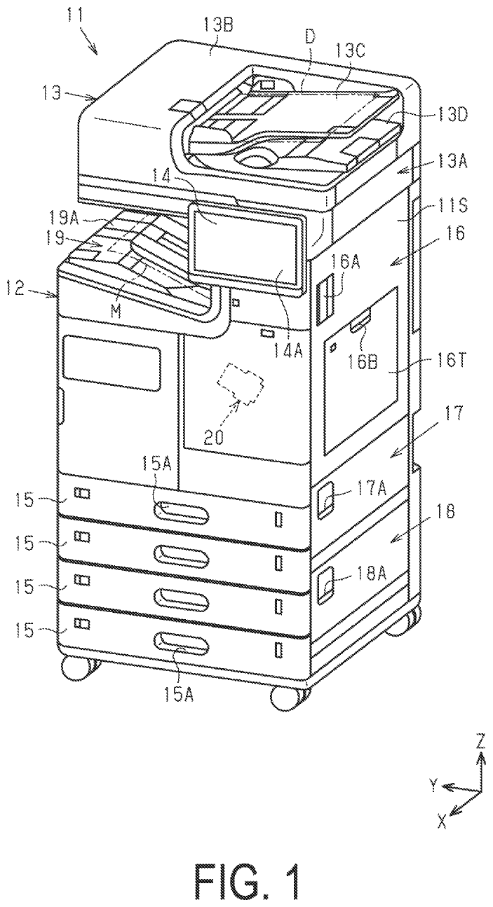

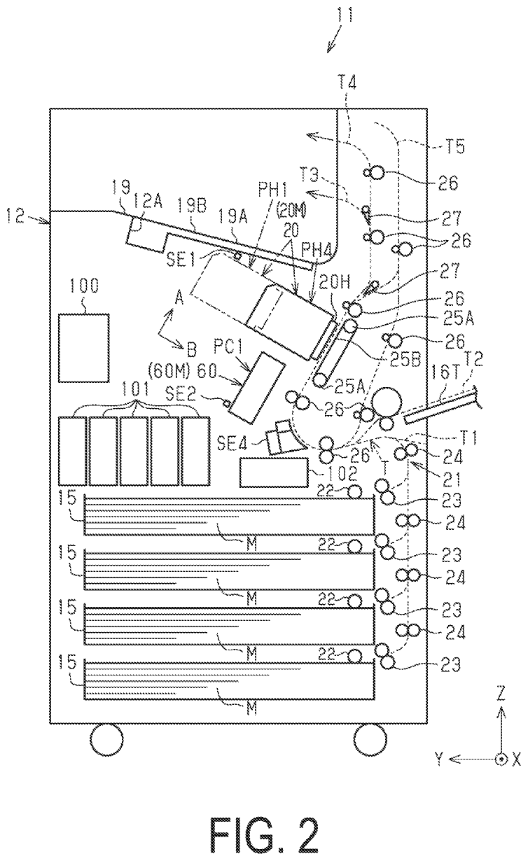

As illustrated in FIG. 1, the recording device 11 includes an apparatus body 12 having a cuboid shape, and an image reading unit 13 disposed above the apparatus body 12. The apparatus body 12 includes a transport path T (see FIG. 2) configured to transport the medium M such as a sheet.

The image reading unit 13 includes a reading unit 13A and an auto original-document feeding unit 13B. The auto original-document feeding unit 13B is configured to feed, to the reading unit 13A, an original document D mounted at the original document tray 13C, and also discharge, to a discharge tray 13D, the original document D to which the reading unit 13A has performed reading. Furthermore, in addition to the feed-type reading function in which the original document D during transportation is read, the reading unit 13A also has a reading function of a flat-head type configured to read the original document D placed on the original-document bench exposed when the auto original-document feeding unit 13B is opened.

The recording device 11 may include an operation unit 14 at the apparatus body 12. The operation unit 14 may include a display unit 14A comprised, for example, of a touch panel. That is, it may be possible to employ a configuration in which a user performs a touching operation to the display unit 14A to give an instruction to the recording device 11.

The recording device 11 may include a cassette 15 configured to be able to accommodate a plurality of media M. The cassette 15 may include one stage of cassette 15 or a plurality of stages (four stages in FIG. 1, for example) of cassettes 15. The cassette 15 is installed in the lower portion of the apparatus body 12 so as to be able to be attached and detached through sliding in the X-axis direction using a knob 15A.

As illustrated in FIG. 1, the apparatus body 12 includes a plurality of cover doors 16 to 18 at a side surface 11S thereof. The plurality of cover doors 16 to 18 include knobs 16A to 18A used by a user to perform an open-close operation. The first cover door 16 includes a sheet feeding tray 16T configured to be able to mount a medium M. The sheet feeding tray 16T includes a knob 16B used by a user to perform an open-close operation.

As illustrated in FIG. 1, the recording device 11 includes a recording unit 20 configured to perform recording on the medium M (see FIG. 2). The recording unit 20 performs recording on the medium M fed from the cassette 15 and also on the medium M fed from the sheet feeding tray 16T.

The recording device 11 includes a discharge unit 19 where the medium M (see FIG. 2) after recording is discharged. The discharge unit 19 includes a discharge tray 19A at which the medium M discharged from the apparatus body 12 is loaded.

### Configuration of Inside of Recording Device 11

Next, the configuration of the inside of the recording device 11 will be described with reference to FIG. 2.

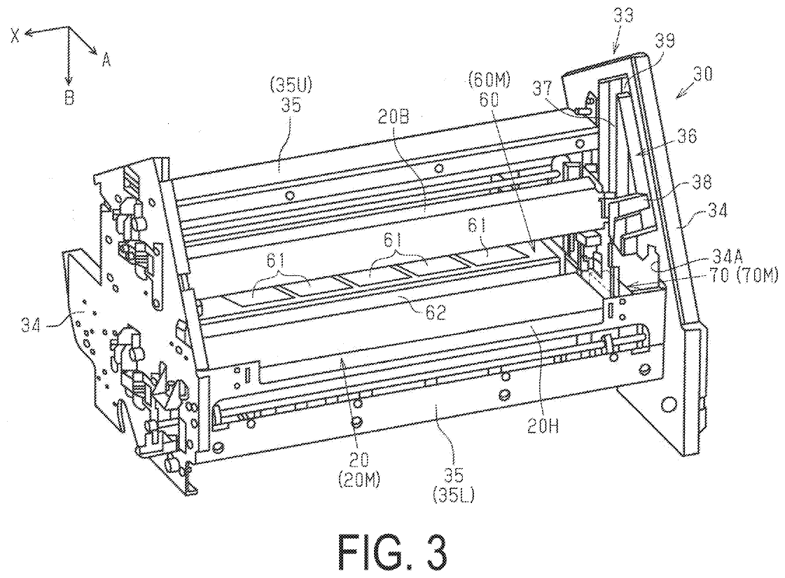

The recording device 11 includes a transport unit 21 configured to transport the medium M, and the recording unit 20 configured to perform recording on the medium M. The recording unit 20 includes a recording head 20H configured to discharge a liquid such as ink. The recording unit 20 discharges the liquid from the recording head 20H to perform recording on the medium M. In addition, the recording device 11 includes a cap unit 60 and a wiper unit 70 (see FIG. 3) that each serve as a maintenance unit configured to perform maintenance of the recording unit 20.

The transport unit 21 includes a transport path T where the medium M is transport. The transport path T is indicated as the dashed line in FIG. 2. The A-B coordinate system indicated on the Y-Z plane is a Cartesian coordinate system. The A direction is equal to a transport direction of the medium M at a recording position that is opposed to the recording unit 20. The direction of the A direction toward the upstream is referred to as the −A direction, and the direction toward the downstream is referred to as the +A direction. In the present embodiment, the A direction is set as a direction inclined toward the −Y direction and the +Z direction as it goes toward the +A direction. Specifically, the A direction is a direction sloped at an angle that falls in a range of 30° to 80° relative to the horizontal direction Y. In particular, in FIG. 2, the A direction is angled substantially at 60° relative to the horizontal direction Y. In this manner, the A direction is a direction in which the transport direction of the medium M intersects, at an acute angle, both the horizontal direction Y and the vertical direction Z.

As illustrated in FIG. 2, the recording unit 20 is configured to be able to move in the B direction that is a direction that is opposed to a transporting belt 25B that functions as a support portion configured to support the medium M. The B direction is a direction inclined at a predetermined angle that is an acute angle relative to the horizontal plane. The B direction is a direction set such that a direction in which the recording head 20H heads toward the transporting belt 25B is the +B direction, and a direction in which the recording head 20H heads away from the transporting belt 25B is the −B direction. The B direction is set as a direction that heads toward the −Y direction and the −Z direction as it heads toward the +B direction. In the present embodiment, the B direction is perpendicular to the A direction on the Y-Z plane.

The recording unit 20 is configured to be able to move between a replacement position PH1 indicated by the long dashed double-short dashed line in FIG. 2 and a recording position PH4 indicated by the solid line in FIG. 2. The recording unit 20 moves from the replacement position PH1 toward the +B direction, thereby being able to move to a plurality of positions including at least the replacement position PH1 and the recording position PH4. In this example, the B direction that is the movement direction of the recording unit 20 is also referred to as a first movement direction B. This first movement direction B is a direction intersecting the vertical direction Z and the horizontal direction Y.

The recording position PH4 is a position where the recording head 20H discharges a liquid such as ink to the medium M to perform recording. The replacement position PH1 is a position where an operator such as a user or a service person replaces the recording unit 20 for the purpose of maintenance. A first sensor SE1 that can detect the recording unit 20 disposed at the replacement position PH1 may be provided within the apparatus body 12. Upon detection, by the first sensor SE1, of the recording unit 20 that has reached the replacement position PH1, driving of a motor 41 may be stopped. In addition, the position of the recording unit 20 when the first sensor SE1 detects the recording unit 20 may be set as the origin point of the recording unit 20 on the movement path.

The discharge unit 19 includes a space portion in which a medium M stacked on a mount surface 19B of the discharge tray 19A is accommodated. In the present embodiment, it is possible to replace the recording unit 20 and the cap unit 60 through a replacement work port 12A exposed when the discharge tray 19A is detached. In other words, the recording unit 20 and the cap unit 60 are configured to be able to be attached to and detached from the apparatus body 12.

In addition, the medium M accommodated in the cassette 15 is transported along the transport path T by a pick-up roller 22 and transport roller pairs 23 and 24. A transport path T1 and a transport path T2 merge with the transport path T. The transport path T1 extends from an external device. The transport path T2 extends from the sheet feeding tray 16T provided at the apparatus body 12.

In addition, the transporting belt 25B, a plurality of transport roller pairs 26, a plurality of flaps 27, a medium width sensor SE4 configured to detect the width of the medium M in the X direction are disposed at positions along the transport path T. The transporting belt 25B is wound around a pair of rollers 25A. The medium M supports the transporting belt 25B at a recording position that is opposed to the recording unit 20. The flap 27 has a function of switching a path through which the medium M is transported.

The transport path T forms a curved portion in a region that is opposed to the medium width sensor SE4, and extends in the A direction in a region downstream of this curved portion. At a portion disposed downstream of the transporting belt 25B, the transport path T includes a transport path T3 and a transport path T4 heading toward the discharge unit 19, and also includes an inverting path T5 configured to invert the front and back of the medium M. Note that, at the time of both-side printing, the medium M for which recording has been finished on the first surface is inverted in the inverting path T5 such that the second surface of the medium M turns into the recording surface. Note that the transporting belt 25B may employ an air-drawing system or an electrostatic drawing system configured to draw the medium M.

The recording unit 20 includes the recording head 20H at a position that is opposed to the transporting belt 25B and the B direction. The recording unit 20 is able to discharge a liquid onto the entire width direction X of the medium M. That is, the recording head 20H is a line head having a plurality of nozzles that can perform recording at the same time over the range that covers the entire area of the medium M in the width direction X. However, the recording unit 20 may employ a serial recording system mounted at a carriage and configured to discharge ink while moving in the width direction X of the medium M.

The recording device 11 includes the cap unit 60 serving as one example of the maintenance unit that performs maintenance to the recording unit 20. The cap unit 60 is provided so as to be able to advance and retreat in a second movement direction A intersecting the first movement direction B and relative to a portion between the recording unit 20 and the transporting belt 25B. The cap unit 60 covers the recording head 20H when the recording unit 20 is disposed at a retraction position where the recording unit 20 is retracted from the recording position PH4 toward the −B direction.

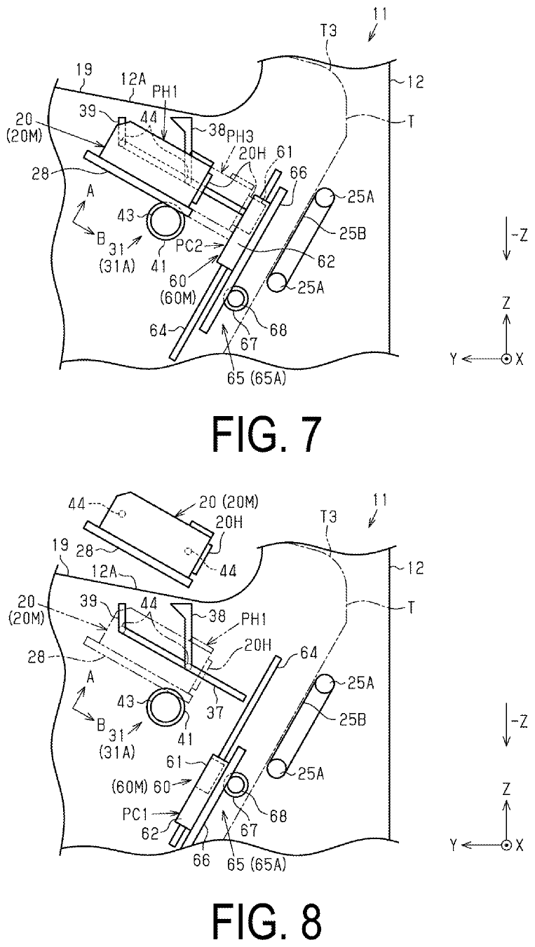

The cap unit 60 is able to move to a capping position PC2 where maintenance is performed to the recording head 20H and also to a retraction position PC1 where the cap unit 60 is retracted from the capping position PC2 toward the −A direction. A second sensor SE2 that can detect the cap unit 60 disposed at the retraction position PC1 may be provided within the apparatus body 12. The position of the cap unit 60 when the second sensor SE2 detects the cap unit 60 may be set as the origin point of the cap unit 60 on the movement path. The recording unit 20 can move to a wiped position (not illustrated) where the recording unit 20 is retracted from the recording position PH4 toward the −B direction by a predetermined distance. The cap unit 60 performs capping in which the recording head 20H disposed at a capped position PH3 (see FIG. 7) slightly descending from the wiped position is covered. During the time when the recording device 11 is in the recording operation, the cap unit 60 stands by at the retraction position PC1. As for the cap unit 60, the position of one end portion of the movement path is set as a replacement position PC3.

In addition, the recording device 11 includes the wiper unit 70 (see FIG. 3) configured to move along a predetermined direction to perform maintenance of the recording unit 20. The wiper unit 70 constitutes one example of the maintenance unit.

Furthermore, the recording device 11 includes a control unit 100 serving to control the recording device 11. In addition, a liquid accommodation unit 101 configured to accommodate a liquid such as ink and a waste-liquid storage unit 102 configured to store a waste liquid such as ink are provided within the apparatus body 12. The liquid accommodation unit 101 is configured to supply a liquid such as ink to the recording head 20H through a tube, which is not illustrated in the drawing. The recording head 20H discharges the liquid such as ink supplied from the liquid accommodation unit 101.

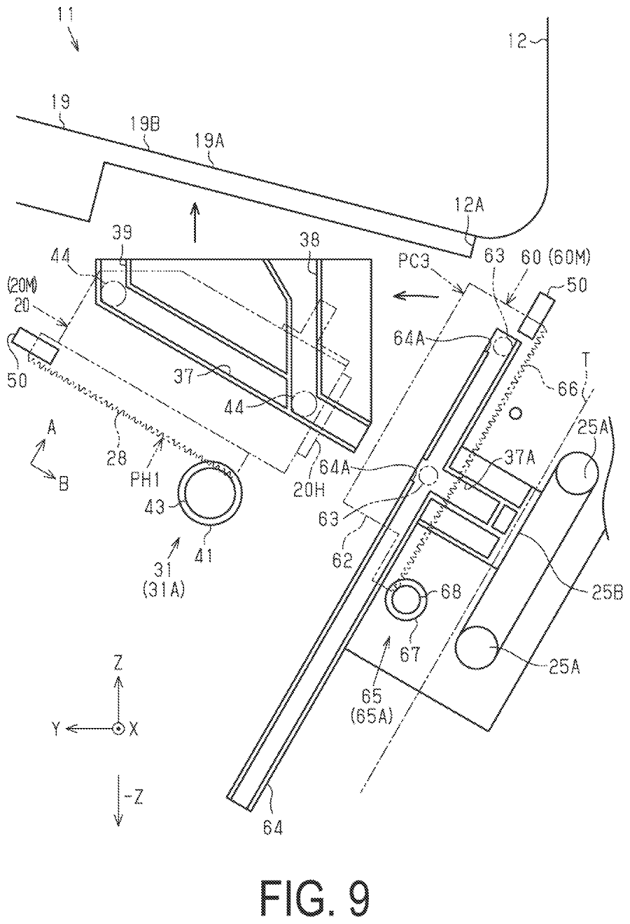

The discharge tray 19A illustrated in FIG. 2 is configured so as to be able to be taken off from the apparatus body 12. Replacement of the recording unit 20 is performed through the replacement work port 12A exposed when the discharge tray 19A is detached. In addition, replacement of the cap unit 60 is also performed through the same replacement work port 12A. Upon receipt of an instruction to replace the recording unit 20, the control unit 100 causes the recording unit 20 to move to the replacement position PH1. Furthermore, upon receipt of an instruction to replace the cap unit 60, the control unit 100 causes the cap unit 60 to move to the replacement position PC3 (see FIG. 9).

Configuration of Motion Unit 30

Next, the configuration of a motion unit 30 will be described with reference to FIG. 3.

As illustrated in FIG. 3, the recording device 11 includes the motion unit 30. The motion unit 30 includes a main body frame 33 serving as a framework of the main body. The main body frame 33 includes a pair of side fames 34 and 34 that are opposed to each other in the X direction at a predetermined distance between them, and also includes a plurality of lateral frames 35 connecting the pair of side fames 34 and 34.

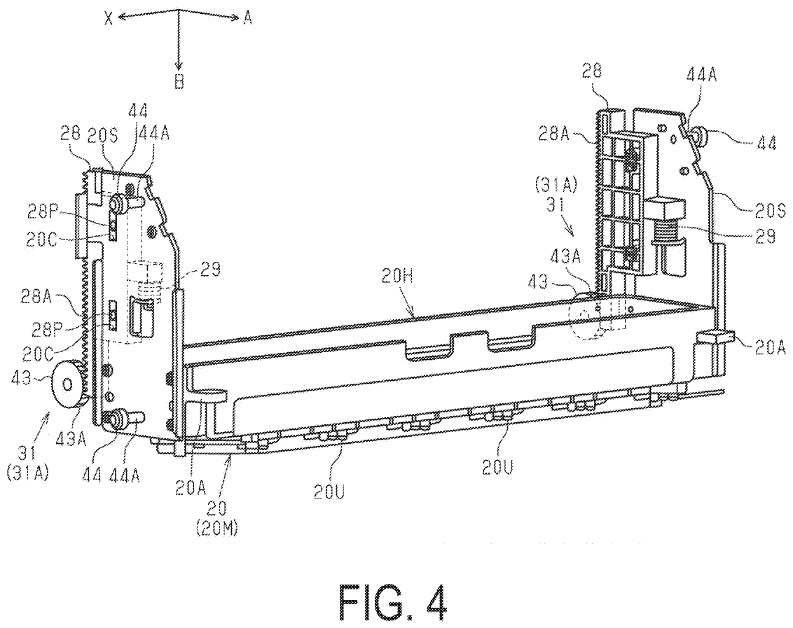

The motion unit 30 holds the recording unit 20, the cap unit 60, and the wiper unit 70 so as to be able to move along corresponding movement directions that intersect each other. The motion unit 30 includes a first movement mechanism 31 (see FIGS. 4 and 7) configured to move the recording unit 20 in the first movement direction B (B direction) serving as one example of a movement direction. In addition, the motion unit 30 includes a second movement mechanism 65 (see FIG. 7) configured to move the cap unit 60 in the second movement direction A (A direction), and also includes a third movement mechanism (not illustrated) configured to move the wiper unit 70 in a third movement direction X (X direction). In this manner, the recording device 11 includes the recording unit 20 as a first mobile body 20M, the cap unit 60 as a second mobile body 60M, and the wiper unit 70 as a third mobile body 70M.

A guide member 36 configured to guide the recording unit 20 so as to be able to move in the first movement direction B is attached at each of two inner surfaces of the pair of side fames 34 and 34 that are opposed to each other. The two guide members 36 are disposed so as to be substantially symmetrical with respect to the center of the main body frame 33 in the X direction. Thus, the guide member 36 at the −X direction side will be described whereas the guide member 36 at the +X direction will not be described.

As illustrated in FIG. 3, the guide member 36 includes a first guide portion 37 extending in the first movement direction B, and second guide portions 38 and 39 branching from middle portions of the first guide portion 37 and extending in the Z direction. Each of the guide portions 37 to 39 is a groove-type rail opened at the +X direction. A guide roller 44 (see FIG. 4) of the recording unit 20 is inserted into the groove of the first guide portion 37. The first guide portion 37 guides the recording unit 20 in the first movement direction B.

Configuration of Recording Unit 20, Cap Unit 60, and Wiper Unit 70

Next, detailed configuration of the recording unit 20 will be described with reference to FIG. 3.

The recording unit 20 includes the recording head 20H at the lower end portion in the +B direction. As a guide roller 44 (see FIG. 4) such as a plurality of rollers fastened at both side portions in the width direction X is guided by the first guide portion 37, the recording unit 20 is attached to the main body frame 33 in a state of being able to move in the first movement direction B. The pair of first guide portions 37 (only one of them is illustrated in FIG. 3) are attached at the inner surfaces of the pair of side fames 34 in a state of extending in the first movement direction B.

The recording unit 20 is guided by the first guide portion 37 to move to a plurality of stop positions including the recording position PH4 and the replacement position PH1 (see FIG. 2 for both of them). Specifically, the recording unit 20 moves along the first guide portion 37, thereby being able to stop at a plurality of stop positions including the replacement position PH1, the wiped position (not illustrated), the capped position PH3, and the recording position PH4 in the +B direction.

The cap unit 60 includes a plurality of caps 61 and a cap carriage 62 at which the caps 61 are mounted. The cap unit 60 moves in the +A direction from the retraction position illustrated in FIG. 3 to the capping position that is opposed to the recording head 20H. At the capping position, the cap unit 60 performs capping and cleaning to the recording head 20H. The cap unit 60 includes the plurality of caps 61 used to perform capping in which the recording head 20H is covered.

The wiper unit 70 stands by at the retraction position illustrated in FIG. 3, and moves from the retraction position in the +X direction to perform cleaning to wipe the nozzle surface (not illustrated in the drawing) where nozzles of the recording head 20H are opened. In FIG. 3, a through hole 34A is formed at one of the side frames 34, and allows the wiper unit 70 to pass through when the wiper unit 70 moves from the retraction position to a cleaning region where cleaning can be performed. Note that the third movement direction may be a direction other than the X direction, as long as cleaning can be performed without interfering the cap unit 60. In addition, it may be possible to employ a configuration in which the wiper unit 70 can be replaced at the replacement position.

Detailed Configuration of Recording Unit 20 and First Movement Mechanism 31

As illustrated in FIG. 4, the recording head 20H included in the recording unit 20 extends in the width direction X. A pair of plate portions 20A are provided at corresponding end portions, in the width direction X, of the recording head 20H so as to protrude toward the +A direction. The recording unit 20 includes the recording head 20H, and a pair of support plates 20S attached at corresponding end portions, in the width direction X, of the recording head 20H. Note that the pair of support plates 20S are connected through a bar member 20B illustrated in FIG. 3.

As illustrated in FIG. 4, the support plates 20S are each configured as a side plate along the A-B plane, and extend in the −B direction relative to the recording unit 20. The support plate 20S has outer side surfaces in the Y direction. A shaft 44A is provided at corresponding end portions, in the B direction, of each of the outer side surfaces. The shafts 44A each have a cylindrical shape and extend toward the +Y direction and the −Y direction, respectively. The guide roller 44 serving as one example of a guided portion is rotatably attached to the shaft 44A. The guide roller 44 is comprised, for example, of a roller having a ring shape.

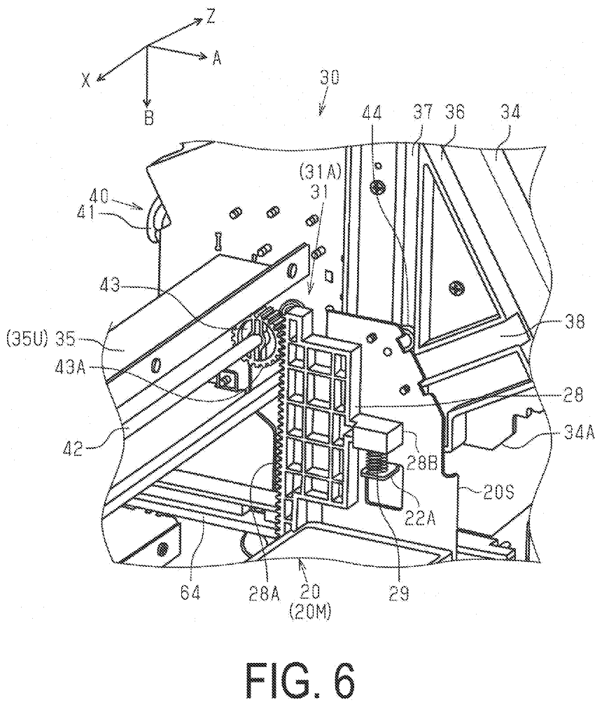

The first movement mechanism 31 is, for example, a rack and pinion mechanism 31A. The rack and pinion mechanism 31A includes a rack 28 and a driving toothed gear 43. The driving toothed gear 43 is driven with driving force of a motor 41 (see FIG. 6) serving as a driving source of the rack and pinion mechanism 31A. The rack and pinion mechanism 31A moves the recording unit 20 in the first movement direction B in which the rack 28 extends. The recording head 20H of the recording unit 20 includes a plurality of unit heads 20U. The plurality of unit heads 20U are arrayed so as to be arranged in the width direction X. Note that, during standby in which a recording operation is not performed, the nozzle surfaces of the plurality of unit heads 20U are covered with the plurality of caps 61 illustrated in FIG. 3.

The rack 28 is provided at the inner surface, in the X direction, of the support plate 20S. The rack 28 includes a pin 28P. The pin 28P protrudes from the rack 28 toward the outside in the X direction. The rack 28 is a plate-shaped member with the X direction being the thickness direction thereof, and extends in the B direction. A toothed portion 28A including a plurality of teeth arranged in the B direction is formed at an end portion, at the −A direction side, of the rack 28.

In addition, an elongated hole 20C penetrating in the X direction and elongated in the B direction is formed in the support plate 20S. The pin 28P is inserted into the elongated hole 20C. Thus, the rack 28 is configured so as to be able to move in the B direction relatively to the support plate 20S. The recording head 20H is fixed to the support plates 20S. Thus, the recording unit 20 is configured so as to be able to move in the B direction relatively to the rack 28.

In addition, as illustrated in FIG. 4, the recording unit 20 includes a bias portion 29 provided between the rack 28 and the recording unit 20 and configured to perform biasing in a direction in which the rack 28 and the recording unit 20 are spaced apart from each other. The bias portion 29 is, for example, a compression spring. The bias portion 29 biases the rack 28 and the support plate 20S in a direction in which they are spaced apart from each other in the B direction. Thus, when the rack 28 is moved in the +B direction in a state in which movement of the recording unit 20 in the B direction that is a descending direction of this unit is restricted, the rack 28 relatively moves in a direction toward the recording unit 20 with the bias portion 29 being deformed in a compressing manner. The bias portion 29 elastically deforms in a range in which the pin 28P is able to move within the elongated hole 20C. Note that the bias portion 29 is not limited to the compression spring, and may be a tension spring or a torsion coil spring.

As illustrated in FIG. 6, the bias portion 29 is held in a state of being able to elastically deform in the B direction and in a state where both ends of the bias portion 29 are engaged with a first stopping portion 28B extending horizontally from the rack 28 and also with a second stopping portion 22A extending horizontally from an inner surface of the support plate 20S. The driving toothed gear 43 that constitutes the first movement mechanism 31 rotates with driving force of the motor 41 serving as a driving source.

Configuration of Adjustment Unit 46

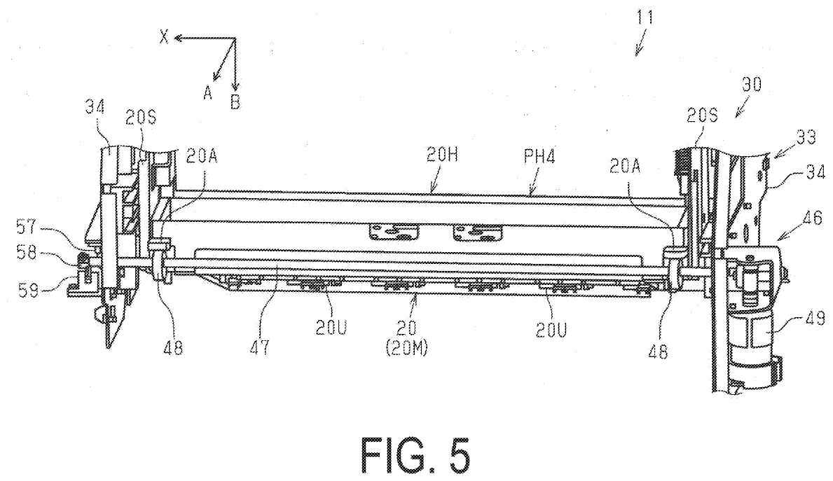

Next, the configuration of an adjustment unit 46 will be described with reference to FIG. 5. As illustrated in FIG. 5, the adjustment unit 46 is provided at the main body frame 33. The adjustment unit 46 has a function of adjusting a gap between the nozzle surface of the recording head 20H and the upper surface (support face) of the transporting belt 25B that supports the medium M. The adjustment unit 46 adjusts the gap to an appropriate value in accordance with types of the medium M.

The adjustment unit 46 includes an eccentric cam 48 serving as one example of a cam member and a cam shaft 47 used to cause the eccentric cam 48 to rotate. Specifically, in addition to the cam shaft 47 and two eccentric cams 48, the adjustment unit 46 includes a motor 49, an adjustment screw 57, a detection target member 58, and a position sensor 59.

The cam shaft 47 is a member elongated in the width direction X, and extends from the side frame 34 at one side to the side frame 34 at the other side. The two eccentric cams 48 are attached to the cam shaft 47. In addition, the outer peripheral surfaces of the two eccentric cams 48 constitute cam profiles. As illustrated in FIG. 5, the outer peripheral surface of the eccentric cam 48 is in contact with a portion of the +B direction of the plate portion 20A of the recording unit 20. With this configuration, as the two eccentric cams 48 rotate in association with the rotation of the cam shaft 47, the position of the recording head 20H is adjusted in the B direction. In addition, driving of the motor 49 is controlled by the control unit 100 (see FIG. 2). This causes the cam shaft 47 to rotate in one direction or a reverse direction.

The outer peripheral surface of the eccentric cam 48 illustrated in FIG. 5 constitutes a cam profile. Both end portions of the cam shaft 47 are rotatably supported at the side frames 34 through bearings (not illustrated). As illustrated in FIG. 5, the adjustment unit 46 includes an adjustment screw 57. By performing rotation operation of the adjustment screw 57, it is possible to adjust the position, in the B direction, of the eccentric cam 48.

The detection target member 58 attached to an end portion of the cam shaft 47 is detected by the position sensor 59. The position sensor 59 is, for example, an optical-type sensor. The position sensor 59 is configured to detect a rotational angle of the cam shaft 47 on the basis of the presence or absence of blockage of light by the detection target member 58. The control unit 100 causes the motor 49 to drive on the basis of the rotational angle of the cam shaft 47 detected by the position sensor 59, thereby adjusting the rotational angle of the eccentric cam 48. In the present embodiment, descending of the recording unit 20 is stopped in a state where the plate portion 20A of the recording head 20H is in contact with the cam profile of the eccentric cam 48. With this configuration, the recording head 20H is disposed at the recording position PH4 according to the type of the medium M. In this manner, the recording device 11 includes the eccentric cam 48 that is brought into contact with the recording unit 20 to define the position of the recording unit 20. At this time, the recording unit 20 is pressed against the eccentric cam 48 by the bias portion 29. With the compression deformation of the bias portion 29, errors in the stop positions of the rack 28 are absorbed.

As illustrated in FIG. 6, a drive unit 40 is configured to include the motor 41, a gear portion that is not illustrated in the drawing, a rotary shaft 42, and the driving toothed gear 43. Drive of the drive unit 40 is controlled by the control unit 100 (see FIG. 2). The rotary shaft 42 that rotates with driving force of the motor 41 is configured such that, in a state of extending in the Y direction, both end portions of the rotary shaft 42 are rotatably supported by the pair of side frames 34. The driving toothed gear 43 is attached to both end portions of the rotary shaft 42 in the Y direction. A toothed portion 43A that meshes with the toothed portion 28A of the rack 28 is formed at the outer peripheral portion of the driving toothed gear 43. The motor 41 causes the rotary shaft 42 and the driving toothed gear 43 to rotate in one direction or the reverse direction through a gear portion that is not illustrated in the drawing. As the drive unit 40 drives and rotates the driving toothed gear 43 in this manner, the drive unit 40 causes the recording unit 20 to reciprocate in the B direction.

About Replacement of Recording Unit 20

As illustrated in FIG. 7, the recording unit 20 is configured such that meshing of the rack and pinion mechanism 31A can be disengaged at the replacement position PH1 furthest away from the transporting belt 25B (see FIG. 1) in the B direction. The recording unit 20 is able to move along the first movement direction B to the recording position PH4 (see FIG. 2) where recording is performed on the medium M and the replacement position PH1 where the mobile body is attachable and detachable. The recording unit 20 is configured such that, at the replacement position PH1 to which the recording unit 20 is moved along the first guide portion 37 in the −B direction, the recording unit 20 is pulled upward along the second guide portions 38 and 39 in the +Z direction, whereby meshing of the rack and pinion mechanism 31A is disengaged.

As illustrated in FIG. 7, when the recording unit 20 is disposed at the replacement position PH1, the plurality of guide rollers 44 are disposed at branch points of the first guide portion 37 extending in the B direction and the two second guide portions 38 and 39 extending in the vertical direction Z. When the recording unit 20 is disposed at the replacement position PH1, the guide rollers 44 are able to move in the vertical direction Z along the two second guide portions 38 and 39, whereby the recording unit 20 is attachable to and detachable from the apparatus body 12. In the present embodiment, the attachment and detachment direction is equal to the vertical direction Z, and hence, is also referred to as the attachment and detachment direction Z.

The recording unit 20 includes the guide roller 44 serving as one example of a guided portion guided by the first guide portion 37 and the second guide portions 38 and 39. When the recording unit 20 is disposed at the replacement position PH1, the guide roller 44 is disposed at the branch point between the first guide portion 37 and the second guide portions 38 and 39. In this state, the guide roller 44 is able to move in the attachment and detachment direction Z. When the guide roller 44 is disposed at positions other than the branch point, that is, when the recording unit 20 is disposed at positions other than the replacement position PH1, movement of the guide roller 44 in directions (including the attachment and detachment direction Z) other than the first movement direction B is restricted by the guiding surface of the first guide portion 37.

When the recording unit 20 is disposed at the replacement position PH1 illustrated in FIG. 7, an operator is able to attach and detach the recording unit 20 through the replacement work port 12A exposed by removing the discharge tray 19A disposed above the recording unit 20. By moving the recording unit 20 in the attachment and detachment direction Z while causing the second guide portions 38 and 39 to guide the guide roller 44, the operator is able to attach and detach the recording unit 20. The operator is able to take the recording unit 20 out from the replacement work port 12A as indicated by the solid line in FIG. 8 by pulling the recording unit 20 upward in the attachment and detachment direction Z while causing the two second guide portions 38 and 39 to guide the guide roller 44 of the recording unit 20 disposed at the replacement position PH1.

Configuration of Guiding of Recording Unit 20

As illustrated in FIG. 9, the recording device 11 includes a mobile body 20M including the recording unit 20 configured to perform recording on the medium M. In the recording device 11, the mobile body 20M is configured so as to be able to move and be attachable and detachable. The recording device 11 includes the first guide portion 37 configured to guide the mobile body 20M along the first movement direction B, and also includes the second guide portions 38 and 39 bifurcating from the first guide portion 37 and configured to guide the mobile body 20M along the attachment and detachment direction Z intersecting the first movement direction B. The first guide portion 37 and the second guide portions 38 and 39 are not perpendicular to each other. Note that the first guide portion 37 includes a first guide portion 37A disposed at a position on the transporting belt 25B side and discontinued at the middle in order to secure the movement path for the cap unit 60.

The recording device 11 includes the rack and pinion mechanism 31A as the first movement mechanism 31. The rack and pinion mechanism 31A includes the rack 28 and the driving toothed gear 43, and causes the recording unit 20 to move in the first movement direction B. The rack 28 is attached to the recording unit 20. The driving toothed gear 43 in a state of meshing with the rack 28 rotates with driving force of the motor 41. As the motor 41 drives and rotates in the forward direction, the driving toothed gear 43 rotates clockwise in FIG. 9, and the recording unit 20 descends toward the +B direction. On the other hand, as the motor 41 drives and rotates in the backward direction, the driving toothed gear 43 rotates counterclockwise in FIG. 9, and the recording unit 20 ascends toward the −B direction.

As illustrated in FIG. 9, when the recording unit 20 is disposed at the replacement position PH1, the rack 28 is disposed at a position where meshing with the driving toothed gear 43 is disengaged at the end portion, on the +B direction side, of the rack 28 in the longitudinal direction thereof. As meshing between the rack 28 and the driving toothed gear 43 is disengaged, the recording unit 20 is positioned at the replacement position PH1 even if the driving toothed gear 43 keeps rotating in the backward direction. However, during a period of time when the driving toothed gear 43 keeps rotating in the backward direction, the rack 28 still continuously receives force from the driving toothed gear 43.

The first movement direction B in which the recording unit 20 is guided by the first guide portion 37 and moves is a direction intersecting the vertical direction Z. That is, the first movement direction B intersects the attachment and detachment direction Z. In addition, the rack 28 is disposed above the driving toothed gear 43. In other words, with respect to the driving toothed gear 43, the rack 28 is in a positional relationship in which the rack 28 vibrates due to tooth skipping when the rack 28 receives force in a direction in which the rack 28 lifts with the force having a component of the attachment and detachment direction Z from among the force received from the driving toothed gear 43. When the rack 28 receives force in a direction in which the rack 28 lifts in a case where the guide roller 44 is disposed at the branch point, the rack 28 easily moves in the attachment and detachment direction Z. This possibly prompts vibration of the recording unit 20 due to tooth skipping.

Configuration of Guiding of Cap Unit 60

In addition, as illustrated in FIG. 9, the recording device 11 includes the mobile body 60M including the cap unit 60 serving as one of the maintenance units configured to perform maintenance of the recording unit 20. In the recording device 11, the mobile body 60M is configured to be able to move and be attachable and detached. The recording device 11 includes a first guide portion 64 configured to guide the mobile body 60M in the second movement direction A, and also includes a second guide portion 64A bifurcating from the first guide portion 64 and configured to guide the mobile body 60M along the attachment and detachment direction intersecting the second movement direction A. The second guide portion 64A is an opening portion formed in the first guide portion 64. Note that, although the second guide portion 64A is an opening portion, the direction in which the inner wall surface of the opening portion is directed can be regarded as the attachment and detachment direction of the second guide portion 64A. In this respect, the first guide portion 64 and the second guide portion 64A are not perpendicular to each other.

The cap unit 60 includes a plurality of guide rollers 63 serving as one example of a guided portion. As the plurality of guide rollers 63 are guided by the first guide portion 64, the cap unit 60 moves along the first guide portion 64 in the second movement direction A.

The recording device 11 includes a rack and pinion mechanism 65A as the second movement mechanism 65. The rack and pinion mechanism 65A includes a rack 66 and a driving toothed gear 68 (pinion), and moves the cap unit 60 in the second movement direction A. The rack 66 is attached to the cap unit 60.

The driving toothed gear 68 in a state of meshing with the rack 66 rotates with driving force of a motor 67. As the motor 67 drives and rotates in the forward direction, the driving toothed gear 68 rotates clockwise in FIG. 9, and the cap unit 60 ascends toward the +A direction. On the other hand, as the motor 67 drives and rotates in the backward direction, the driving toothed gear 68 rotates counterclockwise in FIG. 3, and the cap unit 60 descends toward the −A direction. Note that the cap unit 60 may include a bias portion 29 similar to that in the recording unit 20.

When the cap unit 60 is disposed at the replacement position PC3, the guide roller 63 is disposed at a branch point of the first guide portion 64 and the second guide portion 64A. In this state, the guide roller 63 is able to move in the attachment and detachment direction. When the guide roller 63 is disposed at positions other than the branch point, that is, when the cap unit 60 is disposed at positions other than the replacement position PC3, movement of the guide roller 63 in directions (including the attachment and detachment direction) other than the second movement direction A is restricted by the guiding surface of the first guide portion 64.

The second movement direction A in which the cap unit 60 is guided by the first guide portion 64 and moves is a direction intersecting the vertical direction Z. The rack 66 is disposed above the driving toothed gear 68. In other words, with respect to the driving toothed gear 68, the rack 66 is in a positional relationship in which the rack 66 vibrates due to tooth skipping when the rack 66 receives force in a direction in which the rack 66 lifts with the force having a component of the attachment and detachment direction from among the force received from the driving toothed gear 68. When the rack 66 receives force in a direction in which the rack 66 lifts in a case where the guide roller 63 is disposed at the branch point, the rack 66 is able to move in the attachment and detachment direction. This possibly prompts vibration of the cap unit 60 due to tooth skipping.

At the time of replacing the cap unit 60, an operator performs an operation of designating replacement using the operation unit 14. Upon receiving an operation signal from the operation unit 14, the control unit 100 causes the motor 67 to drive and rotate in the forward direction to move the cap unit 60 to the replacement position PC3. Note that, in addition to the replacement position at which the cap unit 60 as a whole can be replaced, it may be possible to separately set a position at which only the cap 61 can be replaced.

As illustrated in FIG. 9, at the time of replacing the cap unit 60, the cap unit 60 is moved to the replacement position PC3 set at the end portion of the movement path that is at the opposite side from the retraction position PC1. When disposed at the replacement position PC3, the cap unit 60 can be attached or detached to or from the apparatus body 12. In other words, meshing of the cap unit 60 with the rack and pinion mechanism 65A can be disengaged at the replacement position PC3. Specifically, by pulling out the cap unit 60 in the −B direction while rotating, counterclockwise in FIG. 9, the cap unit 60 disposed at the replacement position PC3 illustrated in FIG. 9, it is possible to disengage the meshing of the rack and pinion mechanism 65A and withdraw from the first guide portion 64.

Achievement is made of both easiness of replacement of the mobile bodies 20M, 60M, and 70M and suppression of the movement (displacement) of the mobile body 20M, 60M, 70M in the attachment and detachment direction due to tooth skipping at the rack and pinion mechanism 31A, 65A when the three types of mobile bodies 20M, 60M, and 70M are moved to the replacement position PH1, PC3. The three types of mobile bodies 20M, 60M, and 70M basically employ the same configuration of a restriction mechanism 50 that suppresses the tooth skipping at the replacement position PH1, PC3. Thus, below, the recording unit 20 is used as an example of the mobile body, and description will be made of the configuration that can achieve both the easiness of replacement of the recording unit 20 and the suppression of the movement of the recording unit 20 in the attachment and detachment direction Z due to tooth skipping at the rack and pinion mechanism 31A when the recording unit 20 is moved to the replacement position PH1.

When the motor 41 is driven by the amount of drive with a margin being added, there is a period of time when the motor 41 keeps rotating for a while after the first mobile body 20M reaches the replacement position PH1. In addition, even when the motor 41 is configured to stop driving upon detection, by the first sensor SE1, of the recording unit 20 that reaches the replacement position PH1, there may occur a period of time when the motor 41 rotates in a state where the recording unit 20 is disposed at the replacement position PH1.

During these periods, the rack 28 keeps receiving force from the driving toothed gear 43. A component of this force in the attachment and detachment direction Z is force in the +Z direction, and hence, prompts movement of the rack 28 in the +Z direction. Thus, in the present embodiment, the restriction mechanism 50 is provided to reduce force having the component of the attachment and detachment direction Z from among the force that the rack 28 receives from the driving toothed gear 43 when the mobile body 20M is moved to the replacement position PH1. The restriction mechanism 50 restricts movement of the rack 28 or the recording unit 20 to provide the rack 28 or the recording unit 20 with reaction force having a component of the −Z direction that is a direction opposite from the attachment and detachment direction Z. This configuration suppresses the rack 28 and the recording unit 20 moving toward the +Z direction (take-off direction) of the attachment and detachment direction Z.

Configuration of Restriction Mechanism 50

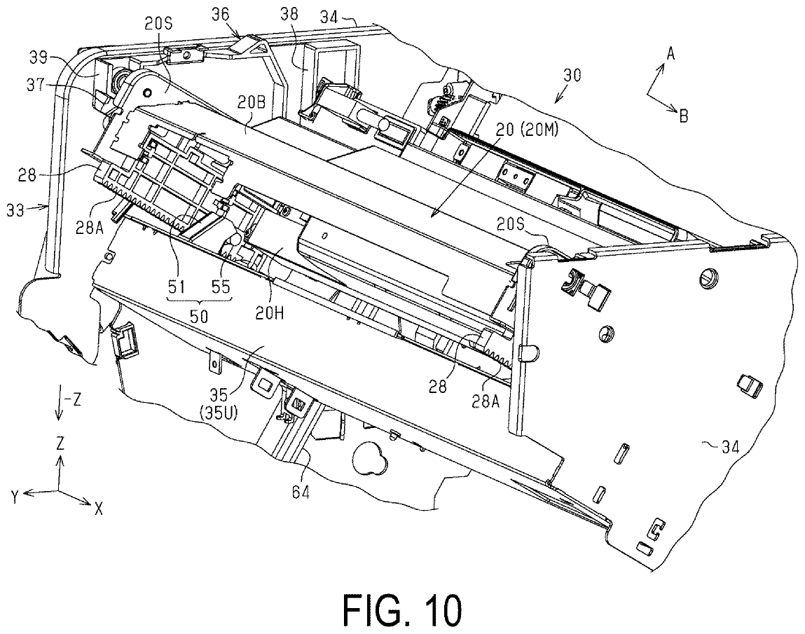

Next, detailed configuration of the restriction mechanism 50 will be described with reference to FIGS. 10 to 16

FIG. 10 illustrates the motion unit 30 including the restriction mechanism 50. The basic configuration and the principle of the restriction mechanism 50 are common among restriction mechanisms 50 provided for individual mobile bodies 20M, 60M, and 70M. Thus, below, description will be made of the configuration of the restriction mechanism 50 applied to the recording unit 20 serving as the first mobile body 20M.

As illustrated in FIG. 10, the motion unit 30 includes the restriction mechanism 50 configured to restrict movement of the recording unit 20 in the attachment and detachment direction Z when the recording unit 20 reaches the replacement position PH1. A pair of restriction mechanisms 50 are provided in the width direction X. That is, one restriction mechanism 50 is provided for each movement mechanism 31.

The restriction mechanism 50 includes a restricting portion 51 fixed at the main body frame 33 and a restricted portion 55 provided at the recording unit 20 side. Specifically, the restricting portion 51 is provided at the upper-side support frame 35U. FIG. 10 illustrates a state where the restricting portion 51 and the restricted portion 55 are in contact with each other. As the restricted portion 55 is brought into contact with the restricting portion 51, movement of the recording unit 20 beyond this point in the −B direction is restricted.

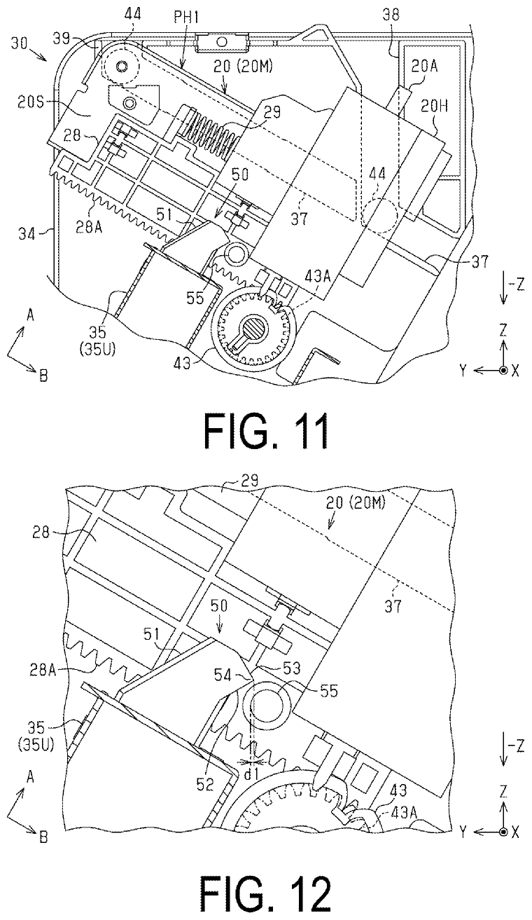

FIG. 11 illustrates a state where the recording unit 20 is disposed at the replacement position PH1. In a state where the recording unit 20 is disposed at the replacement position PH1, a plurality of guide rollers 44 included in the recording unit 20 are disposed at branch points where the first guide portion 37 and the second guide portions 38 and 39 intersect each other. The replacement position PH1 is a position where the mobile body 20M can be guided by the second guide portions 38 and 39 and where the mobile body 20M can be attached and detached. Thus, upon receiving upward force in the attachment and detachment direction Z, the mobile body 20M is able to move in the attachment and detachment direction Z. For example, when the driving toothed gear 43 rotates in a state where the mobile body 20M is disposed at the replacement position PH1, the rack 28 receives force toward the +Z direction (upward) as force having a component of the attachment and detachment direction Z from among force received from the driving toothed gear 43.

As illustrated in FIG. 11, the restricting portion 51 restricts movement of the mobile body 20M in the attachment and detachment direction Z with driving force of the mobile body 20M when the mobile body 20M (recording unit 20) is disposed at the replacement position PH1 where the second guide portion 38, 39 bifurcates from the first guide portion 37 and the mobile body is attachable and detachable.

The recording unit 20 includes the restricted portion 55 configured to be able to be brought into contact with the restricting portion 51. The restricted portion 55 is fixed to the rack 28. The restricted portion 55 is, for example, a cylindrical shaped pin. When the recording unit 20 is disposed at the replacement position PH1, the restricting portion 51 is disposed at a position where the restricted portion 55 at the recording unit 20 is able to be brought into contact. Thus, the restricting portion 51 and the restricted portion 55 are disposed at the same position in the width direction X.

As illustrated in FIG. 12, the restricting portion 51 includes a restriction surface 52 configured to be able to be brought into contact with the restricted portion 55 of the recording unit 20. In addition, the restricting portion 51 includes a guiding surface 53 configured to be brought into contact with the restricted portion 55 when the recording unit 20 is mounted, to guide the restricted portion 55.

The restriction surface 52 intersects the attachment and detachment direction Z. If the restriction surface 52 is parallel to the attachment and detachment direction Z, it would not be possible to restrict the movement of the recording unit 20 in the attachment and detachment direction Z. However, the restriction surface 52 intersects the attachment and detachment direction Z, which makes it possible to restrict the movement of the recording unit 20 in the attachment and detachment direction Z. The force that restricts the movement of the recording unit 20 in the attachment and detachment direction Z increases as the angle that is an acute angle at which the restriction surface 52 intersects the attachment and detachment direction Z becomes closer to the right angle. In other words, the force that restricts the movement of the recording unit 20 in the attachment and detachment direction Z increases with decrease in the angle that is an acute angle formed by the normal-line direction of the restriction surface 52 and the attachment and detachment direction Z. The force that restricts the movement of the recording unit 20 in the attachment and detachment direction Z is zero when the angle formed by the normal-line direction of the restriction surface 52 and the attachment and detachment direction Z is at the right angle.

As it heads toward the +Z direction, the restriction surface 52 is more obliquely sloped relative to the horizontal surface in a direction toward the −Y direction. When the restriction surface 52 intersects the attachment and detachment direction Z, the recording unit 20 receives reaction force having a component of the force that restricts the movement of the recording unit 20 in the attachment and detachment direction Z when the restricted portion 55 is brought into contact with the restriction surface 52. Note that the force that the rack 28 receives from the driving toothed gear 43, the reaction force, and the like will be described later.

FIG. 12 illustrates a state where the recording unit 20 is stopped at the replacement position PH1. In this stopped state, the restricted portion 55 and the restriction surface 52 are slightly spaced apart from each other. By moving the recording unit 20 toward the +Z direction from this state, the recording unit 20 is taken off. In the front view illustrated in FIG. 12, the restriction surface 52 intersects the attachment and detachment direction Z. Thus, the restriction surface 52 and the restricted portion 55 overlap with each other by the interference amount d1 (amount of overlap) in the attachment and detachment direction Z. That is, when the recording unit 20 is moved toward the +Z direction, the restricted portion 55 is in a positional relationship in which it interferes with the corner portion 54 of the restricting portion 51. The interference amount d1 tends to increase, as the normal-line direction of the restriction surface 52 is angled so as to be brought closer to the attachment and detachment direction Z.

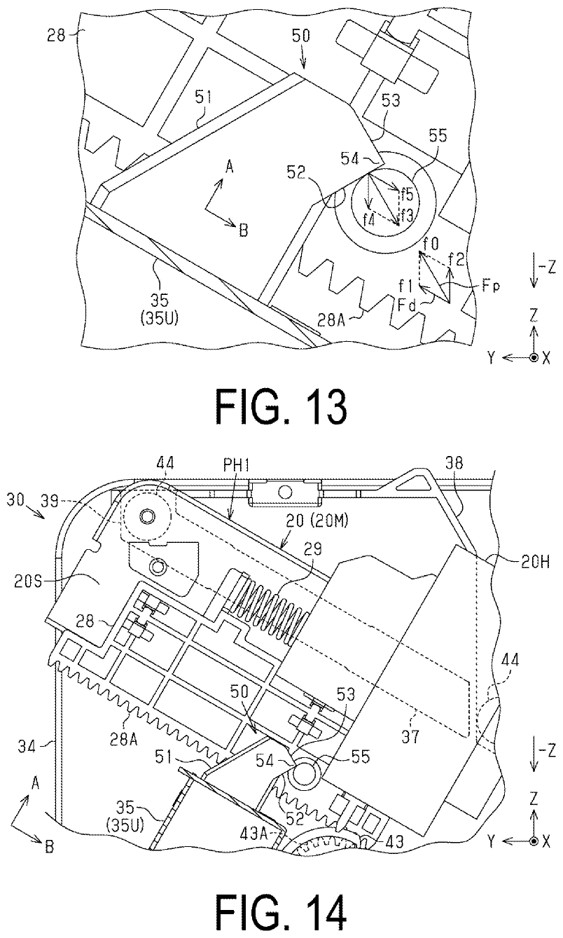

FIG. 13 illustrates a state where the restricted portion 55 is brought into contact with the restriction surface 52. When the recording unit 20 is disposed at the replacement position PH1, the restricted portion 55 is pressed against the restriction surface 52 by the bias portion 29. In a state where the restricted portion 55 is pressed against the restriction surface 52, the bias portion 29 elastically deforms. For this reason, in a process of taking off the recording unit 20 in the +Z direction, the bias portion 29 deforms in a compressing manner. This makes the restricted portion 55 guided by the restriction surface 52, and is displaced in the −Y direction. Thus, as the states in FIGS. 14 to 16 sequentially happen, the restricted portion 55 runs over the corner portion 54 of the restricting portion 51. This makes it possible for the recording unit 20 to be taken off from the replacement position PH1 in the +Z direction.

In this manner, in a process of moving the recording unit 20 along the second guide portion 38, 39 in the +Z direction, the restricted portion 55 is guided in the −Y direction along the restriction surface 52 functioning as the leading surface. With this guiding, the rack 28 moves relatively to the support plate 20S in the +B direction with the bias portion 29 being deformed in a compressing manner. Thus, it is possible to take off the recording unit 20 in the +Z direction (take-off direction) without the restricted portion 55 being blocked by the restricting portion 51.

Next, with reference to FIG. 13, description will be made of the force received by the recording unit 20 at the time of moving to the replacement position PH1, the reaction force received from the restriction surface 52, and the like.

As illustrated in FIG. 13, the rack 28 meshing with the driving toothed gear 43 receives, from the driving toothed gear 43, the force in a pressure angle direction Fp at a predetermined angle (for example, 20°) relative to a driving direction Fd that is a direction in which the toothed portion 28A of the rack 28 extends. That is, the rack 28 receives, from the driving toothed gear 43, force f0 in the pressure angle direction Fp to move in the driving direction Fd.

The force f0 in the pressure angle direction Fp can be divided into forces having two components: force f1 in the driving direction Fd and force f2 in the attachment and detachment direction Z. The force f1 is force that causes the rack 28 to move in the driving direction Fd. The force f2 is force that causes the rack 28 to move in the attachment and detachment direction Z (in particular, in the take-off direction +Z). That is, the force f2 prompts movement of the recording unit 20 in the attachment and detachment direction Z when the recording unit 20 reaches the replacement position PH1 and the guide roller 44 is disposed at a branch point of the first guide portion 37. This force f2 in the attachment and detachment direction Z causes tooth skipping to occur between the rack 28 and the driving toothed gear 43 due to disposition of the recording unit 20 in the attachment and detachment direction Z. In addition, as tooth skipping repeatedly occurs in the state where the recording unit 20 is disposed at the replacement position PH1, the recording unit 20 vibrates.

The rack 28 receives the force f0 in the pressure angle direction Fp from the driving toothed gear 43. A component of this force f0 in the driving direction Fd is the force f1. The force f1 is force in a direction in which the toothed portion 28A of the rack 28 extends. In addition, a component of this force f0 in the attachment and detachment direction Z is the force f2. The restricting portion 51 suppresses this force f2 to restrict the movement of the recording unit 20 in the attachment and detachment direction Z.

As illustrated in FIG. 13, as the restricted portion 55 is brought into contact with the restriction surface 52, the restricted portion 55 receives the reaction force f3 from the restriction surface 52.

The restriction surface 52 is perpendicular to the pressure angle direction Fp that is a direction of force that the rack 28 receives from the driving toothed gear 43. Thus, the reaction force f3 that the rack 28 receives from the restriction surface 52 is force in a direction opposite from the pressure angle direction Fp and having the magnitude substantially equal to the force f0. Force f4 is a component of the reaction force f3 in the attachment and detachment direction Z, and is in a direction opposite from the force f2 and having the magnitude substantially equal to the force f2. Thus, the force f2 in the +Z direction is canceled out by the force f4 in the −Z direction. Note that the force f1 is canceled out by the force f5 that is a component of the reaction force f3 in the driving direction Fd.

In addition, the restriction surface 52 intersects a direction of the force f0 acting on the rack 28 from the driving toothed gear 43. In particular, in the present embodiment, the restriction surface 52 is perpendicular to the direction of the force f0 acting on the rack 28 from the driving toothed gear 43. In addition, the restriction surface 52 intersects the B direction that is a direction in which the rack 28 extends. In the present embodiment, the restriction surface 52 intersects, at an acute angle, the B direction that is a direction in which the rack 28 extends in a state where the recording unit 20 is mounted.

Operations of Embodiment

Next, operations of the recording device 11 will be described. Here, description will be made of a case of replacing the recording unit 20 that is one of the mobile bodies.

By removing the discharge tray 19A of the apparatus body 12, the replacement work port 12A comprised of an opening of the apparatus body 12 is exposed. At the time of replacing the recording unit 20, the driving toothed gear 43 rotates with driving of the motor 41, and the rack 28 meshing with the driving toothed gear 43 is caused to move in the −B direction to cause the recording unit 20 to which the rack 28 is fixed, to move to the replacement position PH1 (FIGS. 2 and 7). An operator pulls up the recording unit 20 disposed at the replacement position PH1 along two second guide portions 38 and 39 in the vertical direction Z, thereby taking it off from the replacement work port 12A as illustrated by the solid line in FIG. 8.

Here, in the process in which the recording unit 20 reaches the replacement position PH1, the control unit 100 causes the motor 41 serving as a driving source to rotate by a predetermined amount to move the recording unit 20 to the replacement position PH1. At this time, the amount of drive of the motor 41 is set to the amount of rotation that allows the recording unit 20 to reliably reach the replacement position PH1. Thus, the driving toothed gear 43 keeps rotating for a while even after the recording unit 20 reaches the replacement position PH1.

As the recording unit 20 reaches the replacement position PH1, the restricted portion 55 is brought into contact with the restriction surface 52 of the restricting portion 51. The restriction surface 52 is a surface perpendicular to the pressure angle direction Fp. Thus, the force f0 in the pressure angle direction Fp is perpendicularly received by the restriction surface 52 that is substantially perpendicular to the direction of the force f0. The force f0 in the pressure angle direction Fp includes components of two forces: the force f1 in the driving direction Fd and the force f2 in the attachment and detachment direction Z. As the force f0 in the pressure angle direction Fp is received, the rack 28 receives, from the restriction surface 52, the reaction force f3 in a direction opposite from the force f0 in the pressure angle direction. With this reaction force f3, the force f0 in the pressure angle direction Fp is canceled. That is, the force f2 that causes the rack 28 to be pushed upward in the Z direction is canceled. Thus, the restriction mechanism 50 restricts the displacement of the rack 28 toward the attachment and detachment direction Z in which the mobile body is attachable and detachable. Thus, when the recording unit 20 reaches the replacement position PH1, it is possible to avoid a phenomenon in which the rack 28 vibrates in the Z direction in conjunction with the tooth skipping relative to the driving toothed gear 43.

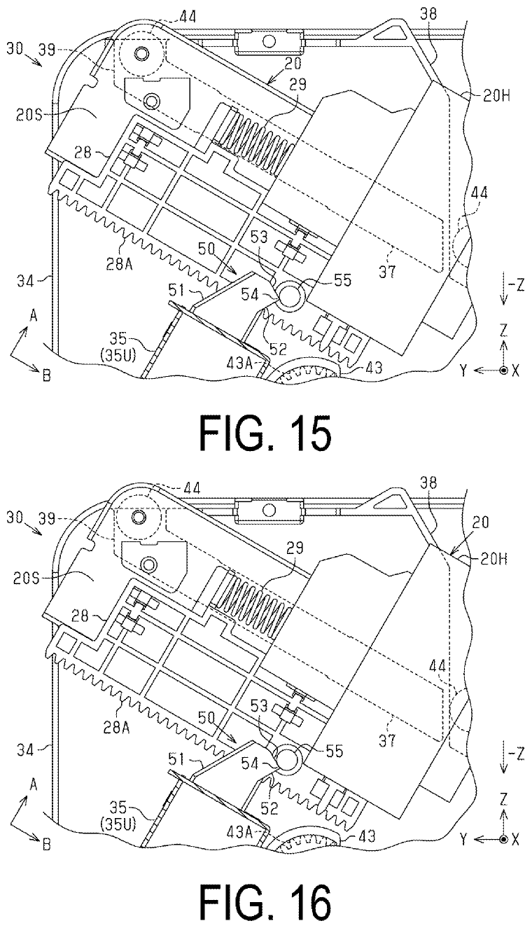

Next, the operator pulls out, in the attachment and detachment direction Z, the recording unit 20 disposed at the replacement position PH1 while causing the plurality of guide rollers 44 to be guided by the second guide portions 38 and 39. As illustrated in FIG. 14, during this process of pulling out the recording unit 20, the restricted portion 55 is displaced relatively to the restricting portion 51 in the +B direction along the restriction surface 52 with the bias portion 29 being deformed in a compressing manner. Then, as illustrated in FIG. 15, the restricted portion 55 runs over the corner portion 54 of the restricting portion 51, and is detached from the restricting portion 51.

After this, the operator installs a new recording unit 20 to be replaced or the recording unit 20 for which a maintenance operation has been completed, along the second guide portions 38 and 39, and mounts it at the first guide portion 37. As the guide roller 44 moves to the branch point along the second guide portions 38 and 39 with its own weight, the recording unit 20 moves in the attachment and detachment direction Z, and is mounted at a position at which it can be guided by the first guide portion 37.

At the time of mounting the recording unit 20, the restricted portion 55 is brought into contact with the guiding surface 53 of the restricting portion 51 as illustrated in FIG. 16, and then, moves relatively to the restricting portion 51 in the +B direction along the guiding surface 53. Thus, the recording unit 20 is mounted at the replacement position PH1 while taking a path that avoids the restricting portion 51 without the restricted portion 55 interfering with the restricting portion 51.

After the recording unit 20 is mounted, the operator uses the operation unit 14 to perform an operation concerning finishing of replacement. The control unit 100 into which this operation signal is inputted causes the motor 41 to drive, thereby moving the recording unit 20 to the capped position PH3. Thus, capping is performed to the recording head 20H of the recording unit 20 using the cap 61 of the cap unit 60 that stands by at the capping position PC2.

Next, description will be made of a case where the cap unit 60 is replaced.

By removing the discharge tray 19A of the apparatus body 12, the replacement work port 12A comprised of an opening of the apparatus body 12 is exposed. At the time of replacing the cap unit 60, the driving toothed gear 68 rotates with driving of the motor 67, and the rack 66 meshing with the driving toothed gear 68 moves toward the +A direction to move the cap unit 60 fixed to the rack 66, to the replacement position PC3. By removing the guide roller 63 from an insertion hole disposed at an end of the first guide portion 64 in the +A direction, the cap unit 60 is removed from the apparatus body 12.

Here, during the process in which the cap unit 60 reaches the replacement position PC3, the control unit 100 causes the motor 67 serving as a driving source to rotate by a predetermined amount to move the cap unit 60 to the replacement position PC3. The amount of drive of the motor 67 at this time is set to the amount of rotation that allows the cap unit 60 to reliably reach the replacement position PC3. Thus, the driving toothed gear 68 keeps rotating for a while even after the cap unit 60 reaches the replacement position PC3.

As the cap unit 60 reaches the replacement position PC3, the restricted portion 55 is brought into contact with the restriction surface 52 of the restricting portion 51. The restriction surface 52 is a surface perpendicular to the pressure angle direction Fp. Thus, the force in the pressure angle direction Fp is perpendicularly received by the restriction surface 52 that is substantially perpendicular to the direction of the force. Here, the force in the pressure angle direction Fp includes components of two forces: the force in the driving direction Fd and the force in the attachment and detachment direction B. As the force in the pressure angle direction Fp is received, the rack 66 receives, from the restriction surface 52, the force in an opposite direction as the reaction force. With this reaction force, the force in the pressure angle direction Fp is canceled. That is, a component of the force that causes the rack 66 to push upward in the B direction is canceled. Thus, the restriction mechanism 50 restricts the displacement of the rack 66 toward the attachment and detachment direction B in which the mobile body is attachable and detachable. Thus, when the cap unit 60 reaches the replacement position PC3, it is possible to suppress a phenomenon in which the rack 66 vibrates in the B direction in conjunction with the tooth skipping relative to the driving toothed gear 68.

After this, the operator mounts, at the first guide portion 64, a new cap unit 60 to be replaced or the cap unit 60 for which a maintenance operation has been completed through the second guide portion 64A. As the guide roller 63 moves to the branch point along the second guide portion 64A with its own weight, the cap unit 60 moves in the attachment and detachment direction B, and is mounted at a position at which it can be guided by the first guide portion 64. After mounting, the operator uses the operation unit 14 to perform an operation concerning finishing of replacement. The control unit 100 into which this operation signal is inputted causes the motor 67 to drive, thereby moving the cap unit 60 to the retraction position PC1.

Thus, with the first embodiment, it is possible to obtain the following effects.

(1) The recording device 11 is configured such that the mobile body 20M including the recording unit 20 or the mobile body 60M, 70M serving as one example of the maintenance unit is movable and detachable. The recording device 11 includes, for example, the mobile body 20M, the first guide portion 37, the second guide portions 38 and 39, and the restricting portion 51. The first guide portion 37 guides the mobile body 20M along the movement direction B. The second guide portion 38, 39 bifurcates from the first guide portion 37 and guides the mobile body 20M along the attachment and detachment direction Z intersecting the movement direction B. The restricting portion 51 restricts movement, based on the driving force f0 of the mobile body 20M, of the mobile body 20M in the attachment and detachment direction Z when the mobile body 20M is disposed at the replacement position PH1 where the second guide portion 38, 39 bifurcates from the first guide portion 37 and the mobile body is attachable and detachable.

When the mobile body 60M, 70M is disposed at the replacement position PH1, PC3, various problems are caused if movement unintentionally occurs in a second direction (for example, the attachment and detachment direction Z, B) intersecting a first direction (for example, the first movement direction B or the second movement direction A) that is a direction in which the first guide portion 37, 64 extends. For example, these various problems include occurrence of tooth skipping between the rack 28, 66 and the driving toothed gear 43, 68 (pinion), generation of abnormal sounds or noise resulting from tooth skipping, disengagement of meshing between the rack 28, 66 and the driving toothed gear 43, 68, or the like. Thus, there is a demand that unintentional movement of the mobile body 60M, 70M in the second direction should be avoided.

With this configuration, when the mobile body 20M is disposed at the replacement position PH1, movement of the mobile body 20M in the attachment and detachment direction Z on the basis of the driving force f0 is restricted. This makes it possible to suppress unintentional movement of the mobile body 20M in the attachment and detachment direction Z. For example, it is possible to suppress inconveniences such as occurrence of vibration or noise resulting from unintentional movement of the mobile body 20M in the attachment and detachment direction Z, or abnormality (tooth skipping, disengagement of meshing, or the like) in transmission of power of the movement mechanism 31, or the like. Note that the mobile body 20M is able to move to the replacement position PH1 where replacement is possible. This makes it easy to attach and detach the mobile body 20M, as compared with a recording device that does not have a configuration in which movement to the replacement position PH1 is possible.

(2) The mobile body 20M is the recording unit 20 configured to perform recording on the medium M. The recording unit 20 is able to move along the movement direction B to the recording position PH4 where recording to the medium M is performed and the replacement position PH1 where the mobile body is attachable and detachable. With this configuration, it is possible to suppress vibration of the recording unit 20 when the recording unit 20 is disposed at the replacement position PH1. In particular, when the recording unit 20 is a line head, the influence of vibration or the like increases due to its heavier weight. However, the configuration makes it possible to effectively suppress vibration.

(3) The restricting portion 51 includes the restriction surface 52 that is able to be brought into contact with the restricted portion 55 of the recording unit 20. The restriction surface 52 intersects the attachment and detachment direction Z. With this configuration, the restriction surface 52 is brought into contact with the restricted portion 55 provided at the recording unit 20, whereby it is possible to restrict movement of the recording unit 20 along the attachment and detachment direction Z.

(4) The rack and pinion mechanism 31A is further provided. The rack and pinion mechanism 31A includes the rack 28 and the driving toothed gear 43, and is configured to move the recording unit 20 in the movement direction B. The rack 28 is attached to the recording unit 20, and includes the restricted portion 55 configured to be able to be brought into contact with the restricting portion 51. The restricting portion 51 includes the restriction surface 52 that is able to be brought into contact with the restricted portion 55. With this configuration, the restriction surface 52 is brought into contact with the restricted portion 55 of the rack 28 provided at the recording unit 20, whereby it is possible to restrict movement of the recording unit 20.

(5) The restriction surface 52 intersects a direction of the force acting on the rack 28 from the driving toothed gear 43. With this configuration, the movement of the rack 28 pushed upward by the driving toothed gear 43 can be directly restricted with the restriction by the restriction surface 52 intersecting the direction of the force acting on the rack 28 from the driving toothed gear 43. This makes it possible to more effectively restrict the movement of the recording unit 20.

(6) The first guide portion 37 and the second guide portion 38, 39 are not perpendicular to each other. The restriction surface 52 intersects a direction in which the rack 28 extends. With this configuration, the amount of interference between the restriction surface 52 and the restricted portion 55 reduces, as compared with a case where restriction is performed by the restriction surface 52 intersecting the direction of force acting on the rack 28 from the driving toothed gear 43. This makes it easy to attach or detach the recording unit 20.

(7) The restricting portion 51 includes the guiding surface 53 configured to be brought into contact with the restricted portion 55 at the time of mounting the recording unit 20, to guide the restricted portion 55. With this configuration, at the time of mounting the recording unit 20, it is possible to mount the recording unit 20 at the replacement position PH1 while avoiding interference between the restricted portion 55 and the restricting portion 51.

(8) There is provided the bias portion 29 provided between the rack 28 and the recording unit 20 and configured to perform biasing in a direction in which the rack 28 and the recording unit 20 are spaced apart from each other. When the recording unit 20 is disposed at the replacement position PH1, the restricted portion 55 is pressed against the restriction surface 52 by the bias portion 29. With this configuration, by resisting the biasing force of the bias portion 29 and causing the rack 28 and the recording unit 20 to approach each other, the restricted portion 55 is caused to move away from the restriction surface 52, and it is possible to release the restriction. This eliminates the need of attaching or detaching the restricting portion 51 at the time of attaching or detaching the recording unit 20, which makes it easy to perform replacement.

(9) The eccentric cam 48 is further provided. The eccentric cam 48 serves as one example of a cam member configured to be brought into contact with the recording unit 20 to define the position of the recording unit 20. The recording unit 20 is pressed against the eccentric cam 48 by the bias portion 29. With this configuration, by pressing the recording unit 20 against the eccentric cam 48 using the bias portion 29, it is possible to improve the accuracy of the position of the recording unit 20. In addition, by sharing the bias portion 29, it is possible to obtain effects such as reduction in the cost, reduction in the size of the device, or the like.

(10) The movement direction B is a direction intersecting the vertical direction Z. The rack 28 is disposed above the driving toothed gear 43. With this configuration, in the configuration in which the rack 28 is disposed above the driving toothed gear 43, the rack 28 and the recording unit 20 ascend and descend with rotation of the driving toothed gear 43 and under its own weight. Thus, when the recording unit 20 unintentionally moves, a problem such as vibration or noise is more likely to occur.

(11) The recording unit 20 includes the guide roller 44 serving as one example of the guided portion guided by the first guide portion 37 and the second guide portion 38, 39. When the recording unit 20 is disposed at the replacement position PH1, the guide roller 44 is disposed at the branch point of the first guide portion 37 and the second guide portion 38, 39. With this configuration, the guided portion is provided at the recording unit 20. This makes it possible to more appropriately guide the recording unit 20, as compared with a configuration in which it is provided at the rack 28 or the like. For example, errors and backlash are less likely to occur.

(12) The recording unit 20 is able to discharge a liquid over the entire region, in the width direction X, of the medium M. With this configuration, the recording unit 20 is, for example, a line head configured to be able to discharge a liquid over the entire region, in the width direction X, of the medium M. As the line head is heavier than a serial head, unintentional movement of the recording unit 20 is more likely to have an adverse effect. However, this configuration is able to suppress the unintentional movement.

(13) The movement direction B is a direction intersecting the vertical direction Z and the horizontal direction Y. With this configuration, movement is performed in a diagonal direction. This makes it possible to reduce the size of the device in the horizontal direction Y. When the position of the recording unit 20 is defined in the vertically downward direction, it is pressed against the cam under its own weight. When the movement direction B is an oblique direction, the effect of pressing under its own weight becomes weak, and hence, it is effective to press by the bias portion 29.

(14) When a restriction mechanism is applied to the cap unit 60 as the mobile body 60M, the cap unit 60 can similarly achieve the effects (1) to (13) in the recording unit 20. That is, in the (1) to (13) described above, the recording unit 20 is replaced with the cap unit 60; the first guide portion 37 is replaced with the first guide portion 64; the second guide portion 38, 39 is replaced with the second guide portion 64A; the rack 28 is replaced with the rack 66; the driving toothed gear 43 is replaced with the driving toothed gear 68; and the guide roller 44 is replaced with the guide roller 63. This makes it possible for the cap unit 60 as the second mobile body 60M to similarly achieve the effects (1) to (13) described above. This similarly applies at the time of application to the wiper unit 70 as the mobile body 70M.

### Second Embodiment

Next, a second embodiment will be described. In the first embodiment, the restriction surface of the restricting portion configured to restrict the further movement of the rack is a surface perpendicular to the pressure angle direction Fp. However, a restriction surface 82 according to the second embodiment is set as a surface perpendicular to the driving direction Fd.

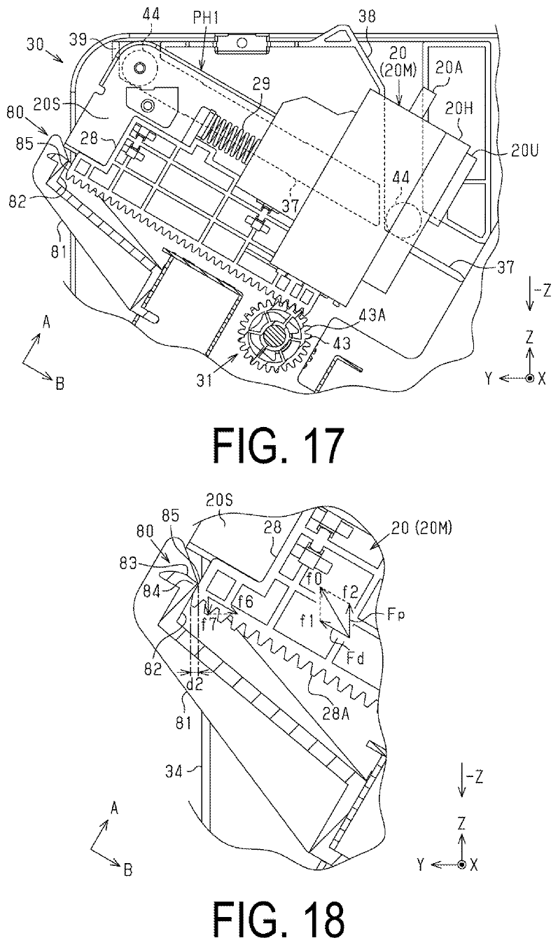

The recording device 11 includes a restriction mechanism 80 differing from the restriction mechanism 50 according to the first embodiment. As illustrated in FIG. 17, the restriction mechanism 80 includes a restricting portion 81 and a restricted portion 85. The restricted portion 85 is provided at the top end of the rack 28. The restricting portion 81 includes the restriction surface 82 configured to be able to be brought into contact with the restricted portion 85 formed at the top end of the rack 28.

The restriction surface 82 according to the present embodiment is perpendicular to the driving direction Fd of the rack 28. For this reason, reaction force f6 is received from the restriction surface 82 when the restricted portion 85 of the rack 28 is brought into contact with the restriction surface 82. Thus, the force f2 that is a component of the driving force f0 in the attachment and detachment direction Z is partially canceled by force f7 that is a component of the reaction force f6 in the attachment and detachment direction Z. In this case, the force of an upper-side component of the driving force f0 in the vertical direction Z slightly remains. However, the force in the −Z direction by the weight of the recording unit 20 including the rack 28 is large, and hence, the force in the +Z direction that is a taking-off direction does not act to the recording unit 20. In this manner, in the present embodiment, the sum of the force f7 and the weight of the recording unit 20 itself is set so as to be greater than the force f2.

In the front view illustrated in FIG. 18, the direction along the restriction surface 82 intersects the attachment and detachment direction Z. Thus, the restriction surface 82 and the restricted portion 85 overlap with each other by the interference amount d2 in the vertical direction Z.

In addition, the restriction surface 52 intersects a direction of the force f0 acting on the rack 28 from the driving toothed gear 43. In the present embodiment, the restriction surface 52 intersects, at an acute angle, the direction of the force f0 acting on the rack 28 from the driving toothed gear 43. In addition, the restriction surface 52 intersects the B direction that is a direction in which the rack 28 extends. In particular, in the present embodiment, the restriction surface 52 is perpendicular to the B direction that is a direction in which the rack 28 extends. Thus, it is possible to easily reduce the interference amount d2 to be lower than the interference amount d1 according to the first embodiment.

Next, operation of the recording device 11 will be described with reference to FIGS. 17 to 20.

For example, when the recording unit 20 that has started movement from the capped position PH3 reaches the replacement position PH1 at the time of replacing the recording unit 20, the restricted portion 85 at the top end of the rack 28 is brought into contact with the restriction surface 82 of the restricting portion 81. As the restriction surface 82 is a surface perpendicular to the driving direction Fd, the restriction surface 82 can vertically receive the force f1 that is a component in the driving direction Fd from among the driving force f0 in the pressure angle direction Fp. Thus, the rack 28 receives, from the restriction surface 82, the reaction force f6 having the magnitude substantially equal to the force f1 in a direction opposite from the force f1. The force f7 that is a component of the reaction force f6 in the attachment and detachment direction Z has the magnitude smaller than the force f4 according to the first embodiment. For this reason, although the effect is smaller than that in the first embodiment, it is possible to restrict the movement of the recording unit 20 in the attachment and detachment direction Z using the force f7 and the weight of the recording unit 20 itself. Thus, when the recording unit 20 reaches the replacement position PH1, it is possible to suppress a phenomenon in which the rack 28 vibrates in the Z direction in conjunction with tooth skipping relative to the driving toothed gear 43. This makes it possible to avoid occurrence of abnormal sound or noise resulting from tooth skipping.

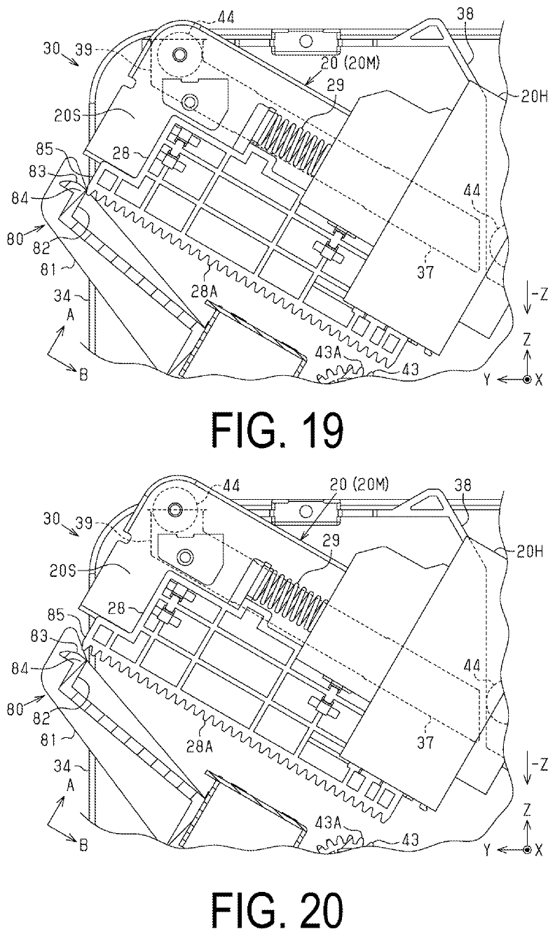

Next, the operator pulls out, in the attachment and detachment direction Z, the recording unit 20 disposed at the replacement position PH1 while causing the plurality of guide rollers 44 to be guided by the second guide portions 38 and 39. As illustrated in FIG. 19, during this process of pulling out the recording unit 20, the restricted portion 55 is displaced relatively to the restricting portion 51 in the +B direction along the restriction surface 82 with the bias portion 29 being deformed in a compressing manner. Then, as illustrated in FIG. 20, the restricted portion 85 runs over the corner portion 84 of the restricting portion 81, and is detached from the restricting portion 81.

After this, the operator installs a new recording unit 20 to be replaced or the recording unit 20 for which a maintenance operation has been completed, along the second guide portions 38 and 39, and mounts the recording unit 20 at the first guide portion 37. As the guide roller 44 moves to the branch point along the second guide portions 38 and 39 with its own weight, the recording unit 20 moves in the attachment and detachment direction Z, and is mounted at the replacement position PH1 at which it can be guided by the first guide portion 37.

At the time of mounting the recording unit 20, the restricted portion 85 is brought into contact with the guiding surface 83 of the restricting portion 81, and then, moves relatively to the restricting portion 81 in the +B direction along the guiding surface 53. Thus, the recording unit 20 is mounted at the replacement position PH1 while taking a path that avoids the corner portion 84 of the restricting portion 81 without the restricted portion 85 interfering with the restricting portion 81.

After the recording unit 20 is mounted, the operator uses the operation unit 14 to perform an operation concerning finishing of replacement. The control unit 100 into which this operation signal is inputted causes the motor 41 to drive, thereby moving the recording unit 20 to the capped position PH3. Thus, capping is performed to the recording head 20H of the recording unit 20 using the cap 61 of the cap unit 60 that stands by at the capping position PC2.

As described in detail above, with the present embodiment, it is possible to obtain the following effect.

(15) The restricted portion 55 is provided at the top end of the rack 28. With this configuration, as the restricted portion 55 is provided at the top end, the amount d2 of interference between the restriction surface 52 and the restricted portion 55 is further reduced. This makes it easy to attach and detach the recording unit 20.

Note that the embodiments described above can be modified into the following modification examples. Furthermore, an example obtained by appropriately combining the above-described embodiments and any of the modification examples described below can be used as a further modified example, and an example obtained by appropriately combining the modification examples described below can be used as a further modified example.
In the embodiments, the leading surface of the restricting portion is a flat surface, and the outer peripheral surface of the restricted portion is a curved surface. However, these may be swapped with each other. That is, it may be possible to employ a configuration in which the leading surface of a restriction surface is a curved surface, and the outer peripheral surface of the restriction target surface is a flat surface. In this case, instead of a round bar (cylindrical shape) as in the first embodiment, the restricted portion may have a prism shape (triangular prism shape or quadrangular prism shape).
It may be possible to employ a configuration in which a driving toothed gear is provided at the mobile body, and a rack is provided at the apparatus body side. For example, it may be possible to employ a configuration in which a driving toothed gear is provided at the recording head 20H, and a rack is provided at the apparatus body 12 side. In addition, for example, it may be possible to employ a configuration in which a driving toothed gear is provided at the cap unit 60, and a rack is provided at the apparatus body 12 side.
The number of rack and pinion mechanisms per one mobile body is not limited to a pair (two), and the number may be one or three or more.
The movement mechanism 31, 65 that moves the mobile body is not limited to the rack and pinion mechanism, and it may be possible to employ other know movement mechanism other than this. For example, it may be possible to employ a belt-type movement mechanism, a linear guide mechanism, a cylinder driving mechanism, or the like.
The restricted portion 55 is not limited to be provided at the rack. For example, in the configuration that performs movement using the rack and pinion mechanism, the restricted portion 55 may be provided at the recording head 20H or the support plate 20S.
The restriction mechanism 50 may be employed only for either one of the first mobile body 20M and the second mobile body 60M. For example, the restriction mechanism may be applied only to the first mobile body 20M, or the restriction mechanism may be applied only to the second mobile body 60M. Furthermore, the restriction mechanism 50 may be applied only to the wiper unit 70. In this manner, depending on necessity, the mobile body for which the restriction mechanism is employed may be selected on an as-necessary basis.
The restriction mechanism 50 according to the first embodiment and the restriction mechanism 80 according to the second embodiment may be applied to a plurality of mobile bodies in the recording device 11.
The restriction mechanism 50, 80 may be employed for the wiper unit 70. In this case, the restriction mechanism 50 may be applied to both the cap unit 60 and the wiper unit 70, or the restriction mechanism 50 may be applied only to the wiper unit 70.
In the embodiments described above, the rack is disposed at the upper side (side opposite in the gravitational direction −Z) of the driving toothed gear (pinion). However, the rack may be disposed at the lower side of the driving toothed gear. In this configuration, when the mobile body is disposed at the replacement position, it is also possible to suppress the movement, based on the driving force f0 of the mobile body, of the mobile body in the attachment and detachment direction. In this case, it may be possible to employ a configuration in which the rack and the driving toothed gear are configured as a combination of a magnet and a ferromagnet, and, by the magnetic force, the mobile body is made less likely to fall with its own weight at the replacement position. Even with such a configuration, by providing the restriction mechanism 50, 80, the mobile body is further less likely to fall with its own weight.
The restricting portion 51, 81 may be able to be attached and detached. When the bias portion 29 is not provided or the restricted portion is provided at a member that can relatively move through a bias portion, it is difficult to take off the mobile body in the attachment and detachment direction due to the interference amount d1, d2. In this case, it may be possible to employ a configuration in which the restricting portion 51, 81 is able to be attached and detached, and the restricting portion 51, 81 is taken off at the time of replacing the mobile body.
The restricting portion 51, 81 does not necessarily completely stop the movement along the attachment and detachment direction. Thus, each of the embodiments is configured such that the mobile body is pressed by the restriction surface 52 in a direction forming an acute angle relative to the attachment and detachment direction. However, it may be possible to employ a configuration in which the restriction surface 52 is provided so as to press the mobile body at the right angle relative to the attachment and detachment direction.
The attachment and detachment direction is not limited to the vertical direction Z, and may be other directions. For example, the attachment and detachment direction may be a direction forming an acute angle relative to the driving direction Fd in front view. In addition, the attachment and detachment direction may be a direction forming an acute angle relative to the pressure angle direction Fp in front view.
The second guide portion configured to guide the cap unit 60 in the attachment and detachment direction is replaced with an opening portion to form a guide rail. In this case, the angle formed by the attachment and detachment direction and a direction normal to the restriction surface 52, 82 may be an acute angle.
In the second embodiment, the restricted portion 85 may be provided at the rear end of the rack 28 that is opposed from the top end. For example, the movement direction of the mobile body at the time of replacement may be a direction opposite from that in each of the embodiments. For example, the replacement position PH1 may be disposed at a more +B direction side than the recording position PH4 of the recording unit 20. In this case, the replacement work port 12A may be provided at a lower portion of the side surface of the apparatus body 12.
The restricting portion may be configured in a movable manner so as to be able to move to a restriction position at which movement of the mobile body in the attachment and detachment direction is restricted at the replacement position and a not-restriction position at which movement of the mobile body in the attachment and detachment direction is allowed. The control unit 100 controls driving of an actuator, which is not illustrated, when the mobile body is moved to the replacement position to dispose the restricting portion to the restriction position. After movement of the mobile body to the replacement position is finished, the control unit 100 causes the restricting portion to be retracted to the not-restriction position. In this case, the position where the restricting portion restricts the mobile body may be a portion other than the rack. For example, it may be possible to directly restrict the guide roller that is the guided portion if a mobile-type restricting portion is employed. Note that it is only necessary that the restriction surface of the restricting portion intersects the attachment and detachment direction. With this configuration, by using the reaction force that the mobile body receives from the restriction surface when the mobile body is brought into contact with the restriction surface, it is possible to apply force having a component in a direction that cancels the component of the force that causes the mobile body to move in the attachment and detachment direction on the basis of the driving force f0 of the mobile body. This makes it possible to suppress the movement of the mobile body in the attachment and detachment direction.
The mobile body is not limited to the recording unit 20, the cap unit 60, or the wiper unit 70, and may be units other that these units. For example, the mobile body may be a flushing unit that is one of the maintenance units. Here, the flushing unit represents no-load discharge in which a liquid is discharged from a nozzle to a location other than the medium M in order to perform refreshing of a liquid such as ink within the nozzle of the recording head. For example, the flushing unit is a mobile body including a carriage in which a flushing box configured to accommodate a liquid of which no-load discharge is performed is mounted. In this case, the movement mechanism may be a rack and pinion mechanism or a mechanism other than this. In addition, it may be possible to provide a restriction mechanism configured to restrict the movement of the flushing unit in the attachment and detachment direction associated with the driving force with which the flushing unit moves in the movement direction when the flushing unit is disposed at the replacement position.
The medium M is not limited to a sheet, and may be a film or a medium made of synthetic resin, cloth, non-woven fabric, a laminate medium, or the like.
The recording device 11 is not limited to an ink jet-type recording device 11, and may be a dot-impact printer or a laser printer. In addition, the recording device 11 may be a textile printing device.

Below, description will be made of technical concepts together with effects understood from the embodiments and the modification examples described above.

(A) A recording device with a mobile body configured to move and be attachable and detachable, the mobile body including a recording unit configured to perform recording on a medium or a maintenance unit configured to perform maintenance of the recording unit, the recording device including: the mobile body; a first guide portion configured to guide the mobile body along a movement direction; a second guide portion bifurcating from the first guide portion and configured to guide the mobile body along a attachment and detachment direction intersecting the movement direction; and a restricting portion configured to restrict movement of the mobile body along the attachment and detachment direction, when the mobile body is disposed at a replacement position where the second guide portion bifurcates from the first guide portion and detachment is possible. For example, the restricting portion restricts movement of the mobile body along the attachment and detachment direction, this movement being based on driving force causing the mobile body to move in the movement direction.

With this configuration, movement in the attachment and detachment direction based on driving force that causes the mobile body to move in the movement direction is restricted when the mobile body is disposed at the replacement position. This makes it possible to suppress the unintentional movement of the mobile body in the attachment and detachment direction. For example, it is possible to suppress inconveniences such as occurrence of vibration or noise resulting from unintentional movement of the mobile body in the attachment and detachment direction, or abnormality (tooth skipping, disengagement of meshing, or the like) in transmission of power of the movement mechanism, or the like. Note that the mobile body is able to move to the replacement position where replacement is possible. This makes it easy to attach or detach the mobile body, as compared with a recording device that does not have any configuration that makes it possible to move to the replacement position.

(B) The recording device described above may be configured such that the mobile body is the recording unit configured to perform recording on the medium, and the recording unit is able to move, along the movement direction, to a recording position where recording is performed on the medium, and the replacement position where the mobile body is attachable and detachable.

With this configuration, it is possible to suppress vibration of the recording unit when the recording unit is disposed at the replacement position. In particular, when the recording unit is a line head, the recording unit is heavy, and the influence of vibration or the like increases. However, it is possible to effectively suppress vibration.

(C) The recording device described above may be configured such that the restricting portion includes a restriction surface configured to be able to be brought into contact with a restricted portion of the recording unit, and the restriction surface intersects the attachment and detachment direction.

With this configuration, the restriction surface is brought into contact with the restricted portion provided at the recording unit. This makes it possible to restrict the movement of the recording unit in the attachment and detachment direction.

(D) The recording device described above may be configured such that the recording device further includes a rack and pinion mechanism including a rack and a driving toothed gear and configured to move the recording unit in the movement direction, the rack includes a restricted portion attached to the recording unit and configured to be brought into contact with the restricting portion, and the restricting portion includes a restriction surface configured to be brought into contact with the restricted portion.

With this configuration, the restriction surface is brought into contact with the restricted portion of the rack provided at the recording unit, which makes it possible to restrict the movement of the recording unit.

(E) The recording device described above may be configured such that the restriction surface intersects a direction of force acting on the rack from the driving toothed gear.

With this configuration, restriction is performed by the restriction surface intersecting the direction of force acting on the rack from the driving toothed gear, and this makes it possible to directly restrict the movement of the rack that is pushed upward by the driving toothed gear. Thus, it is possible to further effectively restrict the movement of the recording unit.

(F) The recording device described above may be configured such that the first guide portion and the second guide portion are not perpendicular to each other, and the restriction surface intersects a direction in which the rack extends.

With this configuration, the amount of interference between the restriction surface and the restricted portion reduces, as compared with a case where restriction is performed by the restriction surface intersecting the direction of force acting on the rack from the driving toothed gear. This makes it easy to attach or detach the recording unit.

(G) The recording device described above may be configured such that the restricted portion is provided at a top end of the rack.

With this configuration, the restricted portion is provided at the top end. This leads to a reduction in the amount of interference between the restriction surface and the restricted portion, which makes it easy to attach or detach the recording unit.

(H) The recording device described above may be configured such that the restricting portion includes a guiding surface configured to be brought into contact with the restricted portion when the recording unit is mounted, to guide the restricted portion.

(I) The recording device described above may be configured such that there is further provided a bias portion provided between the rack and the recording unit, and configured to bias the rack and the recording unit in a direction in which the rack and the recording unit are spaced apart from each other, and when the recording unit is disposed at the replacement position, the restricted portion is pressed against the restriction surface by the bias portion.

With this configuration, by resisting the biasing force of the bias portion and causing the rack and the recording unit to approach each other, the restricted portion is caused to be spaced apart from the restriction surface, and it is possible to remove the restriction. This eliminates the need of attaching or detaching the restricting portion at the time of attaching or detaching the recording unit, which makes it easy to perform replacement.

(J) The recording device described above may be configured such that there is further provided a cam member configured to be brought into contact with the recording unit to define the position of the recording unit, and the recording unit is pressed against the cam member by the bias portion.

With this configuration, by pressing the recording unit against the cam member using the bias portion, it is possible to improve the accuracy of the position of the recording unit. In addition, by sharing the bias portion, it is possible to obtain effects such as reduction in the cost, reduction in the size of the device, or the like.

(K) The recording device described above may be configured such that the movement direction is a direction intersecting a vertical direction, and the rack is disposed above the driving toothed gear.

With this configuration, in the configuration in which the rack is disposed above the driving toothed gear, the rack and the recording unit ascend and descend with rotation of the driving toothed gear and with its own weight. Thus, when the recording unit unintentionally moves, a problem such as vibration or noise is more likely to occur.

(L) The recording device described above may be configured such that the recording unit includes a guided portion guided by the first guide portion and the second guide portion, and when the recording unit is disposed at the replacement position, the guided portion is disposed at a branch point of the first guide portion and the second guide portion.

With this configuration, the guided portion is provided at the recording unit. This makes it possible to more appropriately guide the recording unit, as compared with a configuration in which it is provided at the rack or the like.

(M) The recording device described above may be configured such that the recording unit is configured to discharge a liquid over an entire region, in a width direction, of the medium.

With this configuration, when the recording unit is a line head, the line head is heavier than a serial head. Thus, unintentional movement of the recording unit is more likely to have an adverse effect. However, this configuration is able to suppress the unintentional movement.

(N) The recording device described above may be configured such that the movement direction is a direction intersecting a vertical direction and a horizontal direction.

With this configuration, the mobile body moves in a diagonal direction intersecting the vertical direction and the horizontal direction. This makes it possible to reduce the size of the device in the horizontal direction Y. When the position of the recording unit is defined in the vertically downward direction, it is pressed against the cam member with its own weight. When the movement direction is a diagonal direction, the effect of pressing with its own weight becomes weak, and hence, it is effective to press by the bias portion.

What is claimed is:

1. A recording device with a mobile body configured to move and be attachable and detachable, the mobile body including a recording unit configured to perform recording on a medium or a maintenance unit configured to perform maintenance of the recording unit,
the recording device comprising:
the mobile body;
a first guide portion configured to guide the mobile body along a movement direction;
a second guide portion bifurcating from the first guide portion and configured to guide the mobile body along a attachment and detachment direction intersecting the movement direction; and
a restricting portion configured to restrict movement of the mobile body along the attachment and detachment direction, when the mobile body is disposed at a replacement position where the second guide portion bifurcates from the first guide portion and the mobile body is attachable and detachable.

2. The recording device according to claim 1, wherein
the mobile body is the recording unit configured to perform recording on the medium, and
the recording unit is configured to move, along the movement direction, to a recording position where recording is performed on the medium, and the replacement position where the mobile body is attachable and detachable.

3. The recording device according to claim 2, wherein
the restricting portion includes a restriction surface configured to be brought into contact with a restricted portion of the recording unit, and
the restriction surface intersects the attachment and detachment direction.

4. The recording device according to claim 2 further comprising:
a rack and pinion mechanism including a rack and a driving toothed gear and configured to move the recording unit in the movement direction, wherein
the rack includes a restricted portion attached to the recording unit and configured to be brought into contact with the restricting portion, and
the restricting portion includes a restriction surface configured to be brought into contact with the restricted portion.

5. The recording device according to claim 4, wherein
the restriction surface intersects a direction of force acting on the rack from the driving toothed gear.

6. The recording device according to claim 4, wherein
the first guide portion and the second guide portion are not perpendicular to each other, and
the restriction surface intersects a direction in which the rack extends.

7. The recording device according to claim 6, wherein
the restricted portion is provided at a top end of the rack.

8. The recording device according to claim 4, wherein
the restricting portion includes a guiding surface configured to be brought into contact with the restricted portion when the recording unit is mounted, to guide the restricted portion.

9. The recording device according to claim 4, further comprising:
a bias portion provided between the rack and the recording unit, and configured to bias the rack and the recording unit in a direction in which the rack and the recording unit are spaced apart from each other, wherein,
when the recording unit is disposed at the replacement position, the restricted portion is pressed against the restriction surface by the bias portion.

10. The recording device according to claim 9, further comprising:
a cam member configured to be brought into contact with the recording unit to define a position of the recording unit, wherein
the recording unit is pressed against the cam member by the bias portion.

11. The recording device according to claim 4, wherein
the movement direction is a direction intersecting a vertical direction, and
the rack is disposed above the driving toothed gear.

12. The recording device according to claim 2, wherein
the recording unit includes a guided portion guided by the first guide portion and the second guide portion, and
when the recording unit is disposed at the replacement position, the guided portion is disposed at a branch point of the first guide portion and the second guide portion.

13. The recording device according to claim 2, wherein
the recording unit is configured to discharge a liquid over an entire region, in a width direction, of the medium.

14. The recording device according to claim 2, wherein
the movement direction is a direction intersecting a vertical direction and a horizontal direction.
